(19) United States
(12) Patent Application Publication
(10) Pub. No.: US 2025/0199828 A1
(43) Pub. Date: Jun. 19, 2025

(54) SYSTEMS AND METHODS FOR DYNAMICALLY CONFIGURING A SOFTWARE APPLICATION

(71) Applicant: Bitdrift, Inc., San Francisco, CA (US)

(72) Inventors: Matthew David Klein, Boise, ID (US); Martin Conte Mac Donell, San Jose, CA (US); Vicky Li, San Francisco, CA (US)

(21) Appl. No.: 19/070,466

(22) Filed: Mar. 4, 2025

Related U.S. Application Data
(63) Continuation-in-part of application No. 17/977,921, filed on Oct. 31, 2022.

(51) Int. Cl. G06F 9/451; G06F 9/54

(52) U.S. Cl. CPC G06F 9/451; G06F 9/542

(57) ABSTRACT

A computing system configured to (i) present a user interface (UI) for creating a rule related to observability behavior of a software application, (ii) receive a first set of user inputs for creating a first UI element representing a trigger-event condition to be added to the rule, (iii) create the first UI element, (iv) receive a second set of user inputs for creating a second UI element representing an action to be added to the rule, (v) create the second UI element, and (vi) send, to a computing platform associated with a software provider of the software application, a request to deploy the rule and thereby cause the computing platform to deploy the rule to a set of computing devices installed with the software application, wherein the rule is defined to include the trigger-event condition represented by the first UI element and the action represented by the second UI element.

### CROSS-REFERENCE TO RELATED APPLICATIONS

This application is a continuation-in-part of and claims priority to U.S. Non-Provisional patent application Ser. No. 17/977,921, filed on Oct. 31, 2022 and entitled “SYSTEMS AND METHODS FOR DYNAMICALLY CONFIGURATING A CLIENT APPLICATION,” which is incorporated by reference herein in its entirety.

### BACKGROUND

In today's digital age, client applications of all different kinds play an increasing role in peoples' daily lives. For example, users of mobile devices such as smartphones and tablets may use a wide range of different mobile applications (or “mobile apps” for short), examples of which may include lifestyle apps (e.g., ridesharing apps, travel apps, restaurant apps, dating apps, etc.), social media apps, entertainment apps (e.g., music apps, video apps, book apps, etc.), gaming apps, news apps, and/or productivity apps, among many other possible examples. As another example, users of other types of computers such as laptops and desktops may use a wide range of different desktop applications, which may fall into similar categories. As yet another example, users of mobile devices and computers may use a wide range of web applications that run within web browsers on the users' mobile devices and computers. The types of client applications that could be installed and used on mobile devices and/or other computers may take various other forms as well.

In order to release a new client application (or a new version of a client application) to users of mobile devices or other computers, a software provider typically has to engage in a multi-stage process that involves activities such as planning the client application, designing, developing, and building the client application, testing the client application, preparing the client application for release, and then releasing the client application, among other possible activities, which can be time consuming and costly. Moreover, after the software provider releases a client application, issues with the client application often materialize that may give rise to a need for the software provider's personnel to review and evaluate the operation of the released client application in order to determine whether an updated version of the client should be developed and released.

### SUMMARY

In one aspect, the disclosed technology may take the form of a first method implemented by a computing system installed with a software application comprising a configurable rules engine, where the method involves (i) receiving, from a back-end platform associated with a provider of the software application, configuration data for a given rule related to observability behavior of the software application, wherein the given rule comprises (a) a trigger event that is to cause a change in the observability behavior of the software application and (b) a set of one or more actions related to the observability behavior of the software application that is to be carried out when the trigger event is detected, (ii) based on the received configuration data, configuring a configurable rules engine of the software application to execute the given rule related to observability behavior of the client application, and (iii) initiating a runtime session of the software application, wherein, during the runtime session, the configurable rules engine of the software application executes the given rule by: (a) monitoring for the trigger event, (b) while monitoring for the trigger event, detecting an occurrence of the trigger event, and (c) based on detecting the occurrence of the trigger event, causing the set of one or more actions to be carried out.

In some example embodiments of this first method, the given rule may be defined based on user input from a user associated with the provider of the software application.

Further, in this first method, the trigger event of the given rule may take various forms, and in some example embodiments, the trigger event of the given rule may include one of (i) recordation of a log event that satisfies a specified condition during the runtime session, (ii) detection of a specified change in a state or operation of the software application during the runtime session, (iii) detection of a specified change in a state or operation of the computing system during the runtime session, or (iv) receipt of a specified type of user input from an end user of the software application during the runtime session.

Further yet, in this first method, the function of causing the set of one or more actions to be carried out may take various forms. For instance, in some example embodiments, the function of causing the set of one or more actions to be carried out may involve triggering the software application to report additional log information for the runtime session to the back-end platform, such as one or more additional levels of log information. And in such example embodiments, the function of causing the set of one or more actions to be carried out could additionally involve triggering the software application to capture the additional log information for the runtime session that is to be reported to the back-end platform, or the configurable rules engine could cause the software application to begin provisionally capturing the additional log information for the runtime session prior to detecting the occurrence of the trigger event, in which case the software application may write the provisionally-captured log information to any of various types of storage structures within local data storage of the computing system, including a ring buffer.

In other example embodiments of this first method, the function of causing the set of one or more actions to be carried out may involve causing the software application to report additional contextual information for the runtime session to the back-end platform, which may include one of (i) state information for the client software or (ii) state information for the computing system.

In still other example embodiments of this first method, the function of causing the set of one or more actions to be carried out may involve causing the software application to initiate a live support session or an interactive debugging session with the provider of the software application.

In another aspect, the disclosed technology may take the form of a second method implemented by a computing system, where the second method involves (i) presenting a user interface (UI) for creating a rule related to observability behavior of a software application, (ii) receiving, via the user interface, a first set of one or more user inputs for creating a first UI element representing a trigger-event condition to be added to the rule related to the observability behavior of the software application, (iii) based on the first set of one or more user inputs, creating the first UI element representing the trigger-event condition, (iv) receiving, via the user interface, a second set of one or more user inputs for creating a second UI element representing an action to be added to the rule related to the observability behavior of the software application, (v) based on the second set of one or more user inputs, creating the second UI element representing the action, and (vi) sending, to a computing platform associated with a software provider of the software application, a request to deploy the rule related to the observability behavior of the software application and thereby causing the computing platform to deploy the rule to a set of one or more computing devices that are installed with the software application, wherein the rule is defined to include the trigger-event condition represented by the first UI element and the action represented by the second UI element.

The second method may further involve creating interconnections between UI elements. As one example, the second method may further involve (vii) receiving, via the user interface, a third set of one or more user inputs for creating an interconnection between the first and second UI elements that represents a logical if-then relationship between the trigger-event condition and the action and (viii) based on the third set of one or more user inputs, creating the interconnection between the first and second UI elements that represents the logical if-then relationship between the trigger-event condition and the action, wherein the logical if-then relationship is encoded as part of the rule.

As another example, the second method may further involve creating interconnections between other UI elements. For instance, in embodiments where the trigger-event condition represented by the first UI element is a first trigger-event condition, the second method may further involve (vii) receiving, via the user interface, a third set of one or more user inputs for creating a third UI element representing a second trigger-event condition to be added to the rule related to the observability behavior of the software application; and (viii) based on the third set of one or more user inputs, creating the third UI element representing the trigger-event condition, wherein the rule is defined to include the second trigger-event condition represented by the third UI element. And in such embodiments, the method may further involve (ix) receiving, via the user interface, a fourth set of one or more user inputs for creating a first interconnection between the first and third UI elements that represents a logical AND relationship between the first trigger-event condition and the second trigger-event condition, (x) based on the fourth set of one or more user inputs, creating the first interconnection between the first and third UI elements that represents the logical AND relationship between the first trigger-event condition and the second trigger-event condition, (xi) receiving, via the user interface, a fifth set of one or more user inputs for creating a second interconnection between a given one of the first or third UI elements and the second UI element that represents a logical if-then relationship between the trigger-event conditions and the action, and (xii) based on the fifth set of one or more user inputs, creating the second interconnection between the first and third UI elements that represents the logical if-then relationship between the trigger-event conditions and the action, wherein the logical AND relationship and the logical if-then are encoded as part of the rule. The second method may involve creating interconnections between UI elements in other ways as well.

Further, in the second method, the first and second sets of one or more user inputs for creating UI elements may take various forms. As one possibility, the first set of one or more user inputs for creating the first UI element representing the trigger-event condition includes one or more user inputs that define a client-instance filter for the trigger-event condition, wherein the first UI element as created further represents the client-instance filter for the trigger-event condition. As another possibility, the second set of one or more user inputs for creating the second UI element representing the action may include one or more user inputs that define a client-instance filter for the action, wherein the second UI element as created further represents the client-instance filter for the action. The first and second sets of one or more user inputs for creating UI elements may take other forms as well.

Further yet, in the second method, the user interface for creating the rule may take various forms. As one example, the user interface for creating the rule may include a dialog for creating a UI element representing a condition, wherein the dialog includes one or both of (i) a dropdown list of predefined conditions that are selectable by a user or (ii) a set of one or more input fields for defining the condition in terms of a logical expression, and wherein the first set of one or more user inputs includes at least one user input received via the dialog. As another example, the user interface for creating the rule may include a dialog for creating a UI element representing an action, wherein the dialog includes one or both of (i) a dropdown list of predefined actions that are selectable by a user or (ii) a set of one or more input fields for defining the action in terms of a logical expression, and wherein the second set of one or more user inputs includes at least one user input received via the dialog. As yet another example, the user interface for creating the rule may include an icon for creating an interconnection between the first UI element and the second UI element, wherein the icon is associated with at least one of the first or second UI elements. The user interface for creating the rule may take other forms as well.

In yet another aspect, the disclosed technology may take the form of a computing system (e.g., client device) comprising at least one processor, at least one non-transitory computer-readable medium, and program instructions stored on the at least one non-transitory computer-readable medium that are executable by the at least one processor such that the computing system is configured to carry out the functions of the aforementioned first or second methods.

In yet another aspect, the disclosed technology may take the form of a non-transitory computer-readable medium comprising program instructions stored thereon that are executable to cause a computing system (e.g., a client device) to carry out the functions of the aforementioned method.

It should be appreciated that many other features, applications, embodiments, and variations of the disclosed technology will be apparent from the accompanying drawings and from the following detailed description. Additional and alternative implementations of the structures, systems, non-transitory computer readable media, and methods described herein can be employed without departing from the principles of the disclosed technology.

### BRIEF DESCRIPTION OF THE DRAWINGS

FIG. 1 is a simplified block diagram that illustrates an example network environment in which the disclosed technology may be implemented;

FIG. 2A is a flow diagram that shows example operations that may be carried out in accordance with the present disclosure;

FIG. 2B is a flow diagram that shows example operations that may be carried out in accordance with the present disclosure;

FIG. 3A is illustrates an example user interface (UI) view including a “rule creation” workspace and a side panel for building a new rule, in accordance with the present disclosure;

FIGS. 3B-3D illustrate example “condition” dialogs that may be presented to a user for defining a trigger-event condition, in accordance with the present disclosure;

FIGS. 3E-3G illustrate example UI views including a “rule creation” workspace and a side panel for building a new rule, in accordance with the present disclosure;

FIGS. 3H-3I illustrate example “action” dialogs that may be presented to a user for defining a trigger-event condition, in accordance with the present disclosure;

FIGS. 3J-3L illustrate example UI views including a “rule creation” workspace and a side panel for building a new rule, in accordance with the present disclosure;

FIGS. 4A-4D illustrate example UI views including a “rule creation” workspace for building new rules, in accordance with the present disclosure;

FIG. 5A is a diagram that illustrates an example use case of the disclosed technology during a first period of time while a client application is configured to operate in accordance with the client application's default observability behavior;

FIG. 5B is a diagram that illustrates the example use case of the disclosed technology during a second period of time while the configurable rules engine of the client application is configured to execute an example rule;

FIG. 6A is a diagram that illustrates operations of an example ring buffer, in accordance with the present disclosure;

FIG. 6B is a diagram that illustrates operations of an example ring buffer, in accordance with the present disclosure;

FIG. 7A is a diagram that illustrates operations of an example ring buffer, in accordance with the present disclosure;

FIG. 7B is a diagram that illustrates operations of an example ring buffer, in accordance with the present disclosure;

FIG. 8A is a diagram that illustrates operations of an example ring buffer, in accordance with the present disclosure;

FIG. 8B is a diagram that illustrates operations of an example ring buffer, in accordance with the present disclosure;

FIG. 9 is a simplified block diagram that illustrates some structural components that may be included in an example client device; and

FIG. 10 is a simplified block diagram that illustrates some structural components that may be included in an example back-end platform.

### DETAILED DESCRIPTION

As noted above, client applications of all different kinds play an increasing role in peoples' daily lives. For example, users of mobile devices such as smartphones and tablets may use a wide range of different mobile applications (or “mobile apps” for short), examples of which may include lifestyle apps (e.g., ridesharing apps, travel apps, restaurant apps, dating apps, etc.), social media apps, entertainment apps (e.g., music apps, video apps, book apps, etc.), gaming apps, news apps, and/or productivity apps, among many other possible examples. As another example, users of other types of computers such as laptops and desktops may use a wide range of different desktop applications, which may fall into similar categories. As yet another example, users of mobile devices and computers may use a wide range of web applications that run within web browsers on the users' mobile devices and computers. The types of client applications that could be installed and used on mobile devices and/or other computers may take various other forms as well.

In order to release a new client application (or a new version of a client application) to users of mobile devices or other computers, a software provider typically has to engage in a multi-stage process that involves activities such as planning the client application, designing, developing, and building the client application, testing the client application, preparing the client application for release, and then releasing the client application, among other possible activities, which can be time consuming and costly. Moreover, after the software provider releases a client application, issues with the client application often materialize that may give rise to a need for the software provider's personnel to review and evaluate the operation of the released client application in order to determine whether an updated version of the client application should be developed and released.

To facilitate this evaluation by the software provider, a client application may be designed to capture certain information about runtime sessions of the client application, such as log information and/or associated contextual information (e.g., state information for the client application and/or the client device running the client application), and then periodically send the captured information back to the software provider so that it can be reviewed and evaluated by the software provider's personnel. However, the manner in which client applications capture and report this type of information today—which may be referred to as the client application's “observability” behavior—has many limitations.

One such limitation is that the observability behavior of client applications today—including but not limited to the scope of the log information that is captured and reported by client applications today—is typically hard-coded into the client application prior to its release. For instance, the software provider typically pre-determines which log level setting to utilize for the client application (e.g., a WARN log level, an INFO log level, DEBUG log level, etc.), which defines the scope and granularity of the log information that is captured, and then hard-codes this log level setting into the client application prior to release such that all instances of the released client application will utilize that hard-coded log level setting when capturing log information during runtime sessions. In this respect, the software provider typically pre-determines which log level setting to hard-code into the client application based on a balance between the value provided by the different levels of log information and the resources required to capture and report the different levels of log information, such as the processing and storage required to capture and report the different levels of log information and/or the network bandwidth required to transmit the different levels of log information from the client device running the client application to the software provider's back-end platform.

However, the current approach of hard-coding a client application's observability behavior prior to its release impedes the software provider's ability to later modify the client application's observability behavior in a timely or efficient manner. For instance, when a situation arises where a software provider wishes to change the client application's log level setting so as to enable the client application to capture and report a more granular level of log information (e.g., log entries having a DEBUG-level or a TRACE-level), the software provider typically has to build, test, and release a new version of the client application that is hard-coded with the new log level setting, which is a time consuming (and potentially costly) process that introduces an undesirable time lag between the time when the software provider decides to change the client application's log level setting and the time when instances of the client application can actually begin capturing and reporting log information in accordance with the new log level setting.

Moreover, the current approach of hard-coding the client application's observability behavior prior to its release also inhibits the software provider's ability to tailor the client application's observability behavior based on what takes place the particular runtime session of the client application (e.g., information about the state and/or operation of the client application, the state and/or operation of the client device running the client application, and/or the end-user interaction with the client application). Instead, the client application's observability behavior will be the same for every runtime session, regardless of what took place during the runtime session. For instance, because the client application's log level setting is hard-coded, the same level of log information will be captured and reported by the client application for every runtime session regardless of whether the client application operated normally or experienced an operational issue during the runtime session, which forces the software provider into choosing between two undesirable options—it can either (i) hard-code the client application to capture and report a more granular level of log information (e.g., a DEBUG-level or a TRACE-level) for all runtime sessions at the expense of consuming more compute resources and network bandwidth, or (ii) hard-code the client application to capture and report a less granular level of log information (e.g., an INFO-level, WARN-level, ERROR-level, or FATAL-level) for all runtime sessions at the expense of missing out on other useful log information that could assist the software provider's evaluation of runtime sessions during which the client application experienced operational issues.

The current approach of hard-coding a client application's observability behavior prior to its release may present other problems as well.

To address these and other problems, disclosed herein is new software technology that enables a client application to change its observability behavior dynamically during runtime (e.g., based on the state and/or operation of the client application, the state and/or operation of the client device running the client application, or end-user interaction with the client application during a runtime session) rather than requiring that a new version of the client application be released to implement the changes to the observability behavior. To accomplish this, a client application may be embedded with a configurable rules engine that can be configured to execute one or more rules related to the observability behavior of the client application, where each such rule comprises (i) a respective type of event that is to trigger a change in the observability behavior of the client application if detected, which may be referred to herein as a “trigger event,” and (ii) a respective set of one or more actions related to the observability behavior of the client application that is to be carried out if the respective type of trigger event is detected by the configurable rules engine. In this respect, once a client application's configurable rules engine is configured to execute a given rule related to the observability behavior of the client application, then during runtime sessions of the client application, the configurable rules engine may function to (i) monitor for the given rule's trigger event, and (ii) if an occurrence of the given rule's trigger event is detected, cause the one or more actions related to the observability behavior of the client application to be carried out.

In accordance with the present disclosure, the configurable rules engine that is embedded into the client application can be configured remotely by the software provider of the client application. To facilitate this functionality, disclosed herein is a new software tool that enables users acting on behalf of the software provider (e.g., developers, engineers, analysts, etc.) to create and deploy new rules related to the observability behavior of the client application. This new software tool, which may be referred to herein as a “client configuration tool,” may take the form of a client-server application comprising front-end software (e.g., a web application or mobile application) that runs on client devices of users associated with the given software provider and back-end software that runs on a back-end platform of the given software provider, among other possibilities.

When a user accesses such a client configuration tool via the user's client device, the user may be presented with a user interface for creating a new rule related to the observability behavior of the client application that is to be deployed for execution by at least some instances of the client application. The user may then use the user interface presented via the user's client device to create a new rule related to the observability behavior of the client application, which comprises (i) a respective type of trigger event that is to cause a change in the observability behavior of the client application if detected and (ii) a respective set of one or more actions related to the observability behavior of the client application that is to be carried out if the respective type of trigger event is detected. Once the user has finished creating the rule, the user's client device may send, to the back-end platform hosting the client configuration tool, a request to deploy the new rule for execution by at least some instances of the client application. In turn, the back-end platform may function to (i) identify the particular instances of the client application that are to be configured to execute the new rule, (ii) generate configuration data for the new rule (e.g., data defining the new rule's trigger event and corresponding set of one or more actions), and (iii) transmit the configuration data for the new rule to client devices installed with the identified instances of the client application and thereby cause the configurable rules engine of each such instance of the client application to become configured to execute the new rule, among other possible functions performed by the back-end platform in accordance with the client configuration tool.

At a high level, a trigger event for a rule related to a client application's observability behavior may comprise a set of one or more conditions that may evaluate to true during a runtime session of the given client application. In accordance with the present disclosure, the configurable rules engine may be configured to execute rules specifying any of various different types of trigger events.

For instance, one possible type of trigger event for a rule related to a client application's observability behavior may comprise the recordation of a log entry during a runtime session of the client application that satisfies a certain condition (or set of conditions) specified as part of the rule. This specified condition could take any of various forms, examples of which may include a log entry having a specified severity level (e.g., ERROR or FATAL) or a log entry for a specified type of log event (e.g., a type of log event associated with anomalous or undesirable operation of the client application such as re-routing of a navigational route within a ridesharing application), among other possibilities.

In operation, a configurable rules engine that is configured to execute a rule involving such a trigger event based on the recordation of a log entry may function to monitor the log entries that are recorded by the client application to evaluate whether any of those log entries satisfy the specified condition (e.g., whether any log entry has a specified severity level or memorializes a specified type of log event), and if the configurable rules engine detects that a log entry satisfying the specified condition has been recorded, the configurable rules engine may determine that the rule's trigger event has occurred.

Another possible type of trigger event may comprise a trigger event that is based on some aspect of the state and/or operation of the client application that is not captured within the log information for the client application, such as a specified change in a state variable of the client application or specified type of internal action of the client application that is not recorded a log entry, among other possibilities.

In operation, a configurable rules engine that is configured to execute a rule involving such a trigger event based on the state and/or operation of the client application may function to monitor the state and/or operation of the client application (e.g., based on contextual information that is recorded by the client application), and if the configurable rules engine detects that a specified aspect of the state and/or operation of the client application meets a specified condition (or set of conditions), the configurable rules engine may determine that the rule's trigger event has occurred.

Yet another possible type of trigger event may comprise a trigger event that is based on the state and/or operation of the client device running the client application, which could take any of various forms. As one example, a trigger event based on the state and/or operation of the client device running the client application could comprise a specified type of change in the network connection state of the client device running the client application, such as a change from a first type of network connection (e.g., a cellular connection) to a second type of network connection (e.g., a Wi-Fi connection or a different type of cellular connection), among other possible types of network connection state changes that could serve as a rule's trigger event. As another example, a trigger event based on the state and/or operation of the client device running the client application could comprise a specified type of change in the geographical location of the client device running the client application, such as the client device's location entering into or leaving a specified geographical area (e.g., a geographic area designated by a geofence or the like), among other possible types of location changes that could serve as a rule's trigger event. As yet another example, a trigger event based on the state and/or operation of the client device running the client application could comprise a specified type of change in the compute resources of the client device that are being utilized to run the client application, such as a change in the processing power being used to run the client application (e.g., CPU % or GPU %) that meets a specified threshold or a change in the memory being used for the client application that meets a specified threshold, among other possible types of changes in the compute resources of the client device that could serve as a rule's trigger event. A trigger event based on the state and/or operation of the client device running the client application could take various other forms as well, including trigger events based on other state information for the client device (e.g., battery level of the client device, network library being utilized by the client device, motion state of the client device, etc.).

In operation, a configurable rules engine that is configured to execute a rule involving such a trigger event based on the state and/or operation of the client device running the client application may function to monitor the state and/or operation of the client application (e.g., based on contextual information that is recorded by the client application), and if the configurable rules engine detects that a specified aspect of the state and/or operation of the client device meets a specified condition (or set of conditions), the configurable rules engine may determine that the rule's trigger event has occurred.

Yet another possible type of trigger event may comprise a trigger event that is based on end-user interaction with the client application, such as the detection of a specified type of end-user input, which could take any of various forms. For instance, a trigger event could comprise the detection of end-user input that reports a problem with the application (e.g., a bug report) or the detection of end-user input that is associated with anomalous or undesirable operation of the client application, among other possible types of end-user input that could serve as a trigger event.

In operation, a configurable rules engine that is configured to execute a rule involving such a trigger event based on end-user interaction with the client application may function to monitor the end-user interaction with the client application for a specified type of end-user interaction, and if the configurable rules engine detects the specified type of end-user interaction, the configurable rules engine may determine that the rule's trigger event has occurred.

Still another possible type of trigger event may comprise a trigger event that is based on some other type of sensor data that is captured by the client device while running the client application, such as image data and/or audio data. For instance, one such trigger event could comprise the detection of a particular type of object within image data captured by the client device running the client application (e.g., detection of a particular type of road element within image data captured by the client device running a ridesharing application).

The types of trigger events that can be included in the rules executed by the disclosed configurable rules engine may take various other forms as well, including but not limited to the possibility that if a software provider wishes to implement a more persistent change to the observability behavior of a particular instance of the client application, the software provider could create a rule where the start of a new runtime session serves as the trigger event such that the rule's set of one or more actions related to the client application's observability behavior is carried out for every runtime session after the rule is deployed for execution.

Further, at a high level, an action for a rule related to a client application's observability behavior may comprise any action that facilitates a change in the client application's behavior as it relates to facilitating the software provider's ability to observe the client application's state and/or operation. In accordance with the present disclosure, the configurable rules engine may be configured to execute rules comprising any of various different types of actions related to the observability behavior of the client application.

For instance, one possible type of action related to the observability behavior of the client application that is to be carried out when a trigger event is detected may involve a change to the scope of log information that is captured and/or reported by the client application for a runtime session, such as by causing the client application to capture and/or report one or more additional levels of log entries (e.g., DEBUG- and/or TRACE-levels of log entries) or by causing the client application to capture and/or report one or more additional categories of log entries, among other possibilities.

In operation, the action of changing the scope of log information for a runtime session that is captured and/or reported by the client application may take various forms. As one possible implementation, the action of changing the scope of log information for a runtime session that is captured and/or reported by the client application may involve causing the client application to report additional log information for the runtime session that is provisionally captured and stored throughout the entire runtime session but is not to be reported to the back-end platform unless a trigger event for the reporting action is detected. In such an implementation, the client application may be configured to provisionally capture and store the additional log information (e.g., an additional level or category of log information) throughout the entire runtime session, and if the client application's configurable rules engine detects an occurrence of the trigger event for the action, the configurable rules engine may then cause the client application to report the provisionally-captured log information for the entire runtime session to the back-end platform (e.g., by designating the provisionally-captured log information for reporting along with the other log information that is to be reported by default).

As another possible implementation, the action of changing the scope of log information for a runtime session that is captured and/or reported by the client application may involve causing the client application to capture a snapshot of additional log information available at the time that the trigger event is detected and thereafter report said snapshot to the back-end platform. In such an implementation, the client application may not be configured to provisionally capture or store any additional log information prior to the detection of the trigger event for the action, and if the client application's configurable rules engine detects an occurrence of the trigger event for the action, the configurable rules engine may then cause the client application to capture a snapshot of the additional log information and thereafter report said snapshot to the back-end platform (e.g., by designating the captured snapshot of log information for reporting along with the other log information that is to be reported by default).

As yet another implementation, the action of changing the scope of log information for a runtime session that is captured and/or reported by the client application may involve causing the client application to capture additional log information (e.g., an additional level or category of log information) between the time that the trigger event is detected and the end of the runtime session and thereafter report the additional log information to the back-end platform. In such an implementation, the client application may not be configured to provisionally capture or store any additional log information prior to the detection of the trigger event for the action, and if the client application's configurable rules engine detects an occurrence of the trigger event for the action, the configurable rules engine may then cause the client application to (i) capture additional log information between the time that the trigger event is detected and the end of the runtime session and (ii) report the additional log information to the back-end platform (e.g., by designating the additional log information for reporting along with other log information that is to be reported by default).

The action of changing the scope of log information for a runtime session that is captured and/or reported by the client application may take other forms as well, including but not limited to the possibility that the configurable rules engine may cause the client application to capture and/or report additional log information for some other window of time, such as (i) a window of time that begins some predefined amount of time prior to when a first occurrence of the trigger event was detected and ends at the conclusion of the runtime session or (ii) a window of time that begins when a first occurrence of the trigger event was detected and ends when a predefined amount of time has elapsed since a last occurrence of the trigger event was detected, among other possibilities.

Another possible type of action related to the observability behavior of the client application that is to be carried out when a trigger event is detected may involve a change to the scope of contextual information that is captured and/or reported by the client application for a runtime session, such as by causing the client application to capture and/or report any of various types of additional contextual information for a runtime session in reaction to detecting the trigger event for the action. For example, such an action may involve capturing and/or reporting additional state information for the client application, examples of which may include one or more representations (e.g., screenshots) of the client application's user interface, thread stack information for the client application, and/or a lifecycle state information for the client application (e.g., whether the client application is in the foreground or the background), among other possible types of state information for the client application. As another example, such an action may involve capturing and/or reporting additional state information for the client device running the client application, examples of which may include information about the geographical location of the client device, the network connection state of the client device (e.g., cellular, Wi-Fi, etc.), the level of compute resources being utilized by the client device to run the client application (e.g., processing power usage, memory usage, etc.), and/or the network library being utilized by the client application while running the client application, among other possible types of state information for the client device running the client application. The action may involve capturing and/or reporting additional contextual information that takes other forms as well.

Further, in operation, the action of changing the scope of contextual information for a runtime session that is captured and/or reported by the client application may take various forms. As one possible implementation, the action of changing the scope of contextual information for a runtime session that is captured and/or reported by the client application may involve causing the client application to report additional contextual information for the runtime session that is provisionally captured and stored throughout the entire runtime session but is not to be reported to the back-end platform unless a trigger event for the reporting action is detected. In such an implementation, the client application may be configured to provisionally capture and store the additional contextual information (e.g., one or more additional types of contextual information) throughout the entire runtime session, and if the client application's configurable rules engine detects an occurrence of the trigger event for the action, the configurable rules engine may then cause the client application to report the provisionally-captured contextual information for the entire runtime session to the back-end platform (e.g., by designating the provisionally-captured contextual information for reporting along with the log and/or contextual information that is to be reported by default).

As another possible implementation, the action of changing the scope of contextual information for a runtime session that is captured and/or reported by the client application may involve causing the client application to capture a snapshot of additional contextual information available at the time that the trigger event is detected (e.g., a snapshot of one or more additional contextual attributes) and thereafter report said snapshot to the back-end platform. In such an implementation, the client application may not be configured to provisionally capture or store any additional contextual information prior to the detection of the trigger event for the action, and if the client application's configurable rules engine detects an occurrence of the trigger event for the action, the configurable rules engine may then cause the client application to capture a snapshot of the additional contextual information and thereafter report said snapshot to the back-end platform (e.g., by designating the captured snapshot of contextual information for reporting along with the log and/or contextual information that is to be reported by default).

As yet another implementation, the action of changing the scope of contextual information for a runtime session that is captured and/or reported by the client application may involve causing the client application to capture additional contextual information (e.g., one or more additional types of contextual information) between the time that the trigger event is detected and the end of the runtime session and thereafter report the additional contextual information to the back-end platform. In such an implementation, the client application may not be configured to provisionally capture or store any additional contextual information prior to the detection of the trigger event for the action, and if the client application's configurable rules engine detects an occurrence of the trigger event for the action, the configurable rules engine may then cause the client application to (i) capture additional contextual information between the time that the trigger event is detected and the end of the runtime session and (ii) report the additional contextual information to the back-end platform (e.g., by designating the additional contextual information for reporting along with the log and/or contextual information that is to be reported by default).

The action of changing the scope of contextual information for a runtime session that is captured and/or reported by the client application may take other forms as well, including but not limited to the possibility that the configurable rules engine may cause the client application to capture and/or report additional contextual information for some other window of time during the runtime session, such as (i) a window of time that begins some predefined amount of time prior to when a first occurrence of the trigger event was detected and ends at the conclusion of the runtime session or (ii) a window of time that begins when a first occurrence of the trigger event was detected and ends when a predefined amount of time has elapsed since a last occurrence of the trigger event was detected, among other possibilities.

Yet another possible type of action related to the observability behavior of the client application that is to be carried out when a trigger event is detected may involve initiating a live support session or an interactive debugging session with the software provider. This action of initiating a live support session or an interactive debugging session with the software provider may take various forms. As one possible implementation, the action of initiating a live support session or an interactive debugging session with the software provider may involve transmitting a request to initiate the live support session or interactive debugging session to the software provider's back-end platform, which may then function to establish the live support session or interactive debugging session between the client device running the client application and a client device of one of the software provider's personnel. As another possible implementation, the action of initiating a live support session or an interactive debugging session with the software provider may involve (i) obtaining identifying information for a particular client device associated with the software provider from the software provider's back-end platform and then (ii) transmitting a request to initiate the live support session or interactive debugging session to the client device associated with the software provider. Other implementations are possible as well.

Further, after initiating the interactive debugging session with the software provider, the client application may then engage in back-and-forth communication with the software provider's back-end platform and/or a client device of the software provider's personnel in order to carry out the interactive debugging session. During that time, the end user of the client application may be able to engage with the client application so that the user can attempt to re-create the situation that caused the trigger event to occur, or the end user's interaction with the client application may be temporarily disabled, among other possibilities.

Still another possible type of action related to the observability behavior of the client application that is to be carried out when a trigger event is detected may involve prompting an end user of the client application to provide some input related to the observability behavior of the client application.

For instance, as one possibility, the action of prompting an end user of the client application to provide some input related to the observability behavior of the client application may involve prompting the end user of the client application to input a confirmation that the client application has permission to perform one or more other actions in accordance with a rule that has been satisfied, such as a confirmation that the client application has permission to perform one of the other actions described above (e.g., capturing additional log information, capturing additional contextual information, initiating a live support session or interactive debugging session, etc.). As another possibility, the action of prompting an end user of the client application to provide some input related to the observability behavior of the client application may involve prompting the end user of the client application to change a given setting of the client application and/or the client device. The action of prompting an end user of the client application to provide some input related to the observability behavior of the client application may take other forms as well.

A further possible type of action related to the observability behavior of the client application that is to be carried out when a trigger event is detected may involve sending a notification of the occurrence of the trigger event to the back-end platform, which may then trigger the back-end platform to carry out a set of one or more actions based on the notification. Such back-end actions could take various forms, one example of which may involve instructing other end-user client devices to temporarily change their observability behavior.

The types of actions that can be included in the rules executed by the disclosed configurable rules engine may take various other forms as well. Further, in line with the discussion above, a rule's set of one or more actions may comprise multiple actions that could be of various different types. To illustrate with an example, a rule's set of one or more actions could include both (i) the reporting of an additional level of log information (e.g., a DEBUG-level of log entries) and also (ii) the capture and reporting of certain types of additional contextual information (e.g., a representation of the client application's user interface, thread stack information for the client application, etc.). Many other examples are possible as well.

Further, in at least some implementations, the client application's configurable rules engine could optionally be configured such that, prior to triggering the client application carry out a given action in accordance with a rule that has been satisfied (e.g., one of the actions discussed above), the configurable rules engine may make an initial determination of whether it is appropriate to proceed with the given action, which may then dictate whether or not the configurable rules engine triggers the client application carry out the given action. This initial determination may take any of various forms.

As one possible implementation, the configurable rules engine's initial determination of whether to proceed with a given action in accordance with a rule that has been satisfied may be based on information about the state of the client application and/or the client device running the client application. To illustrate with an example, if the given action involves reporting additional log information and/or contextual information to the back-end platform, the configurable rules engine may check the network connection state of the client device running the client application, and if the client device is connected to the back-end platform via a cellular network rather than a Wi-Fi network, the configurable rules engine may determine that the action of reporting of the additional log information and/or contextual information to the back-end platform should not be carried out (or at least should be delayed until a later time when the client device is connected to the back-end platform via a Wi-Fi network) to as to help avoid incurring additional costs associated with cellular data usage. Many other examples are possible as well.

As another possible implementation, the configurable rules engine's initial determination of whether to proceed with a given action in accordance with a rule that has been satisfied may be based on communications with the back-end platform. For instance, after detecting an occurrence of a trigger event for a given action, the configurable rules engine may cause the client application to notify the back-end platform that the trigger event for the given action has occurred and seek instruction as to whether to carry out the given action, which may in turn cause the back-end platform to respond with an instruction to either (i) carry out the given action, (ii) delay the action until some later point in time, or (iii) refrain from carrying out the given action. In this respect, the back-end platform may determine which of these instructions to send back to the client application in any of various manners, and in at least some examples, the back-end platform may determine which of these instructions to send back to a given instance of the client application based on an analysis of the volume of log information and/or contextual information that is being reported to the back-end platform by other instances of the client application. To illustrate with an example, if the given action involves reporting thread stack information for the client application to the back-end platform if a trigger event is detected, and the back-end platform has already received various thread stacks from other instances of the client application based on the same or a similar trigger event, then the back-end platform may instruct the given instance of the client application to refrain from reporting additional thread stack information for the client application despite the fact that the given trigger event was detected. the back-end platform's determination of which of the instructions to send back to a client application that has detected a trigger event may take various other forms as well.

As yet another possible implementation, in line with the discussion above, the configurable rules engine's initial determination of whether to proceed with a given action in accordance with a rule that has been satisfied may be based on input from an end user of the client application.

The configurable rules engine's initial determination of whether to proceed with a given action in accordance with a rule that has been satisfied may take other forms as well.

Advantageously, the disclosed technology provides various improvements over the existing technology for configuring a client application's observability behavior. For instance, unlike the existing technology, the disclosed technology provides a software provider with the ability to update the observability behavior of a client application in a timely and efficient manner by configuring the configurable rules engine disclosed herein to execute a rule that triggers a change to the observability behavior of the client application during runtime, rather than having to build, test, and release a new version of the client application. In this way, a software provider can effect a change to the client application's observability behavior in as little as a few minutes, rather than the days or weeks that it typically takes to update a client application's observability behavior via a new release.

Further, unlike the existing technology, the disclosed software technology provides a software provider with the ability to tailor a client application's observability behavior on a session-by-session basis based on what actually takes place during the runtime session of the client application, which enables the software provider to continue collecting a baseline set of log information (and perhaps a baseline set of contextual information) for runtime sessions where no trigger event was detected while at the same time enabling the software provider to collect a more in-depth set of log information and/or contextual information for runtime sessions where a trigger event was detected.

Further yet, unlike the existing technology, the disclosed software technology provides a software provider with the ability to change the observability behavior of different instances of the client application in different ways, which allows for additional customization of the client application's observability behavior.

The disclosed technology provides various other improvements over the existing technology for configuring a client application's observability behavior as well.

In accordance with the present disclosure, a client application's configurable rules engine could also be configured to execute one or more rules related to some other aspect of the client application's operation as well (i.e., some aspect of the client application's operation that does not relate to its observability behavior), where each such rule comprises (i) a respective type of trigger event that is to trigger a change in the operation of the client application if detected, and (ii) a respective set of one or more actions related to the operation of the client application that is to be carried out if the respective type of trigger event is detected by the configurable rules engine. In this respect, once a client application's configurable rules engine is configured to execute such a rule, then during runtime sessions of the client application, the configurable rules engine may likewise function to (i) monitor for the given rule's trigger event, and (ii) if an occurrence of the given rule's trigger event is detected, cause the one or more actions related to the operation of the client application to be carried out.

Further, in accordance with the present disclosure, a client application could be configured to perform additional or modified functionality that is embodied in the form of executable code (or sometimes referred to as executable instructions or executable logic) received from a back-end platform, where such executable code, when executed by the client device running the client application, causes the client device to perform the additional or modified functionality while running the client application. To facilitate this functionality, the client configuration tool described above may enable a user acting on behalf of the software provider to create or otherwise input executable code for causing a client application to perform additional or modified functionality, and the client application may be embedded with a configurable code engine that is operable to load and execute code for performing the additional or modified functionality that is received from a back-end platform. In this respect, a client application could be embedded with one or both of a configurable rules engine and a configurable code engine, and in an implementation where the client application is embedded with both a configurable rules engine and a configurable code engine, it is also possible that such engines could either be standalone engines or be integrated together into a single configurable engine. Further, the additional or modified functionality of a client application that is embodied in the form of executable code could take any of various forms, and in at least some implementations, may include functionality for applying rules related to the observability behavior of the client application that are similar to those described herein in the context of the configurable rules engine (e.g., rules comprising a trigger event and one or more actions). However, such functionality could take other forms as well.

While the disclosed software technology is described herein in the context of client applications that have been installed on client devices, one of ordinary skill in the art will understand and appreciate that client applications running on client devices are one example type of software applications that run on computing systems, and that the disclosed software technology may likewise be utilized with other types of software applications running on other types of computing systems (e.g., servers, other types of endpoint devices, etc.), so as to enable other types of software applications running on other types of computing systems to change their operation dynamically during runtime (e.g., based on the state and/or operation of the software application, the state and/or operation of the computing device running the software application, etc.) rather than requiring that a new version of such software applications be released to implement the changes to the operation of the software applications. In particular, as with the client applications described herein, another type of software application may be embedded with a configurable rules engine that can be configured to execute one or more rules related to the operation of the software application (e.g., the observability behavior of the software application), where each such rule comprises (i) a respective type of trigger event and (ii) a respective set of one or more actions related to the operation of the software application that is to be carried out if the respective type of trigger event is detected by the configurable rules engine. Additionally or alternatively, as with the client applications described herein, another type of software application may be embedded with a configurable code engine that is operable to load and execute code for causing the software application to perform additional or modified functionality that is received from a back-end platform.

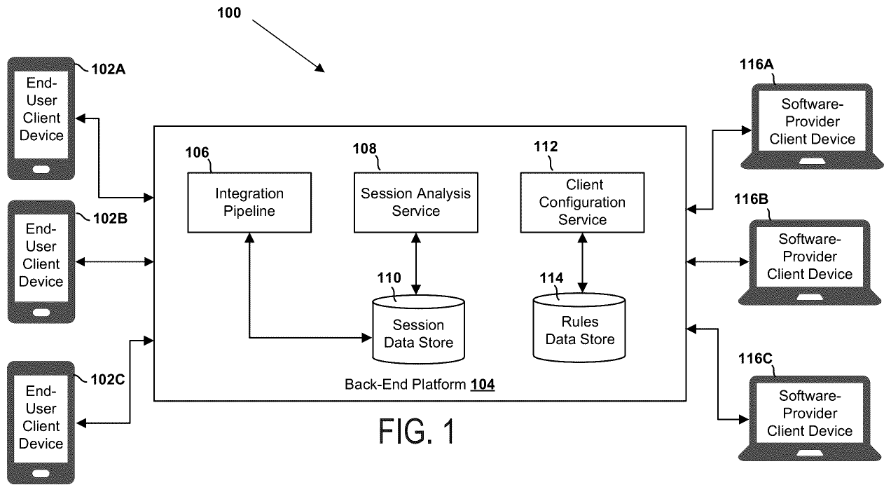

Turning now to FIG. 1, a simplified block diagram is provided that illustrates an example network environment 100 in which the disclosed technology for dynamically configuring the observability behavior of a given client application released by a given software provider may be implemented. As shown in FIG. 1, the example network environment 100 may include a plurality of end-user client devices 102 that are installed with a given client application, of which end-user client devices 102A, 102B, and 102C are shown as representative examples, a back-end platform 104 of the given software provider, and a plurality of software-provider client devices 116, of which software-provider client devices 116A, 116B, and 116C are shown as representative examples. Further, while the disclosed technology is at times described below with reference to the end-user device 102A and the software-provider client device 116A, it should be understood that the discussion may be applicable to any of the end-user devices 102A-C and any of the software-provider client devices 116A-C shown in FIG. 1.

In line with the discussion above, the given client application that is installed on each of the end-user client devices 102A-C can take any of various forms, including but not limited to any of the different forms of client applications described above (e.g., a mobile application, desktop application, web application, or the like). Further, in line with the discussion above, the given client application may be embedded with the configurable rules engine that is disclosed herein.

In general, each of the end-user client devices 102A-C may take the form of any client device that is capable of running an instance of the given client application. In this respect, each of the end-user client devices 102A-C includes hardware components such as one or more processors, data storage, one or more communication interfaces, and input/output (I/O) components, among other possible hardware components. The end-user client devices 102A-C also include software components such as operating system software and the given client application, among various other possible software components. As representative examples, each of the end-user client devices 102A-C could be any of a smartphone, a tablet, a laptop, or a desktop computer, among other possibilities, and it should be understood that different end-user client devices 102A-C could take different forms (e.g., different types and/or models of client devices).

Further, as shown in FIG. 1, each of the end-user client devices 102A-C may be configured to communicate with the back-end platform 104 of the given software provider over a respective communication path. Each of these respective communication paths may generally comprise one or more data networks and/or data links, which may take any of various forms. For instance, each respective communication path between an end-user client device 102 and the back-end platform 104 may include any one or more of Personal Area Networks (PANs), Local Area Networks (LANs), Wide Area Networks (WANs) such as the Internet or cellular networks, cloud networks, and/or point-to-point data links, among other possibilities. Further, the data networks and/or links that make up each respective communication path may be wireless, wired, or some combination thereof, and may carry data according to any of various different communication protocols. Although not shown, the respective communication paths may also include one or more intermediate systems, examples of which may include a data aggregation system and host server, among other possibilities. Many other configurations are also possible.

As further shown in FIG. 1, the back-end platform 104 of the given software provider may comprise an integration pipeline 106, a session analysis service 108, a session data store 110, a client configuration service 112, and a rules data store 114, among other possibilities. Each of these functional components of the back-end platform 104 may be configured to perform certain back-end functionality in accordance with the present disclosure.

For instance, the integration pipeline 106 of the back-end platform 104 may generally be configured to (i) receive information for runtime sessions of the given client application that was captured and reported by the end-user client devices 102A-C, such as log information and/or associated contextual information, (ii) prepare such information for storage in the session data store 110 and subsequent use by the session analysis service 108, wherein such preparation may involve performing certain pre-processing operations on the log information (e.g., validation, cleansing, deduplication, filtering, aggregation, summarization, enrichment, restructuring, reformatting, translation, mapping, etc.), and then (iii) write the received information for runtime sessions of the given client application to the session data store 110, which may then be accessible by the session analysis service 108 as well as other functional subsystems of the back-end platform 104.

Further, the session analysis service 108 of the back-end platform 104 may generally be configured to perform back-end functionality for enabling users associated with the given software provider to review and analyze information for runtime sessions of the given client application (e.g., log information and/or associated session information), which may involve (i) receiving a request from a given software-provider client device 116 to access information for a given runtime session of the given client application, (ii) retrieving certain information for the given runtime session of the given client application from the session data store 110 (e.g., session details, log information, and/or associated contextual information), and (iii) transmitting a response to the given software-provider client device 116 that comprises at least a portion of the retrieved information for the given runtime session of the given client application along with instructions for presenting the information, among other possible back-end functions related to the review and analysis of information for a runtime session that may be performed by the session analysis service 108.

Further yet, the client configuration service 112 of the back-end platform 104 may generally be configured to perform back-end functionality for enabling users associated with the given software provider to create and deploy new rules related to the observability behavior of the client application. This back-end functionality may involve (i) receiving a request from a given software-provider client device 116 to deploy a new rule related to the observability behavior of the client application for execution by at least one instance of the client application, where the new rule may comprise a respective type of trigger event that is to cause a change in the observability behavior of the client application and a respective set of one or more actions related to the observability behavior of the client application that is to be carried out when the trigger event is detected, (ii) generating configuration data for the new rule (e.g., data defining the new rule's trigger event and corresponding set of one or more actions), (iii) transmitting the configuration data for the new rule to end-user client device(s) 102 installed with the identified instance(s) of the client application and thereby causing the configurable rules engine of each such instance of the client application to become configured to execute the new rule, and (iv) writing the configuration data for the new rule to the rules data store 114, perhaps along with other data related to the new rule such as execution data for the rule (e.g., a listing of runtime sessions during which the rule was satisfied), any of which may then be accessible by the client configuration service 112 as well other functional subsystems of the back-end platform 104. The client configuration service 112 may be configured to perform other back-end functions for creating and deploying rules related to the observability behavior of the client application as well.

In practice, the back-end platform 104 of the given software provider may comprise some set of physical computing resources (e.g., processors, data storage, etc.) utilized to implement the foregoing functional subsystems. This set of physical computing resources may take any of various forms. As one possibility, the back-end platform 104 may comprise cloud computing resources supplied by a third-party provider of “on demand” cloud computing resources, such as Amazon Web Services (AWS), Amazon Lambda, Google Cloud Platform (GCP), Microsoft Azure, or the like. As another possibility, the back-end platform 104 may comprise “on-premises” computing resources of the given software provider (e.g., servers owned by the given software provider). As yet another possibility, the back-end platform 104 may comprise a combination of cloud computing resources and on-premises computing resources. Other implementations of the back-end platform 104 are possible as well.

Further, in practice, the functional components of the example back-end platform 104 may be implemented using any of various software architecture styles, examples of which may include a microservices architecture, a service-oriented architecture, and/or a serverless architecture, among other possibilities, as well as any of various deployment patterns, examples of which may include a container-based deployment pattern, a virtual-machine-based deployment pattern, and/or a Lambda-function-based deployment pattern, among other possibilities.

Turning lastly to the software-provider client devices 116A-C, each of the software-provider client devices 116A-C may generally take the form of any client device that is capable of running front-end software for accessing and interacting with the session analysis service 108 and/or the client configuration service 112, such as front-end software for a session analysis tool and/or a client configuration tool. In this respect, each of the software-provider client devices 116A-C includes hardware components such as one or more processors, data storage, one or more communication interfaces, and I/O components, among other possible hardware components, as well as software components such as operating system software and front-end software that is capable of interfacing with the session analysis service 108 and/or the client configuration service 112 (e.g., a mobile application, desktop application, or web browser), among various other possible software components. As representative examples, each of the software-provider client devices 116A-C could be any of a smartphone, a tablet, a laptop, or a desktop computer, among other possibilities, and it should be understood that different software-provider client devices 116A-C could take different forms (e.g., different types and/or models of client devices).

Further, each of the software-provider client devices 116A-C may be configured to communicate with the back-end platform 104 of the given software provider over a respective communication path that may take a similar form to the respective communication paths between the end-user client devices 102A-C may and the back-end platform 104.

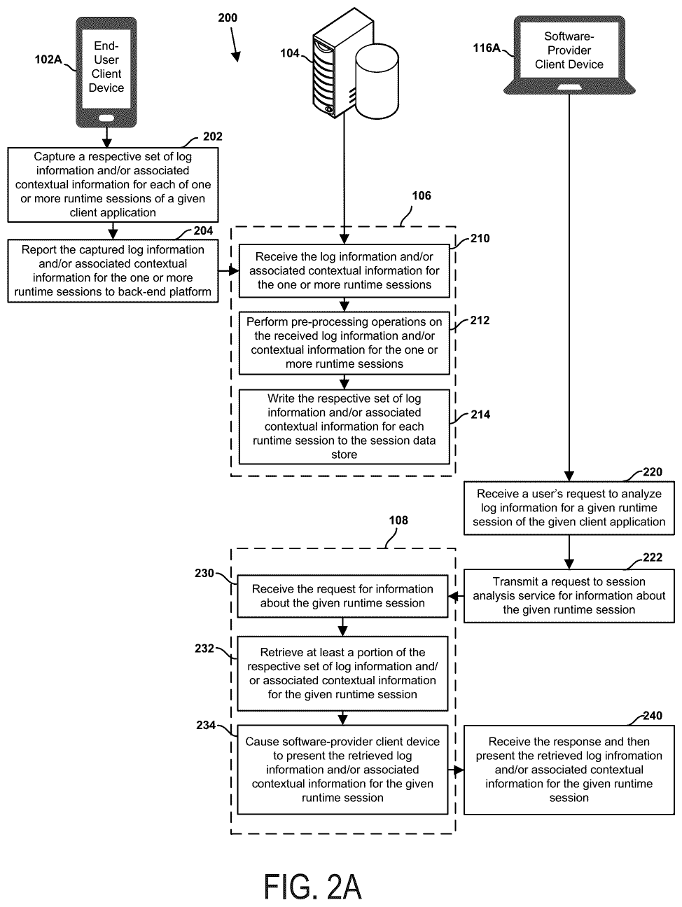

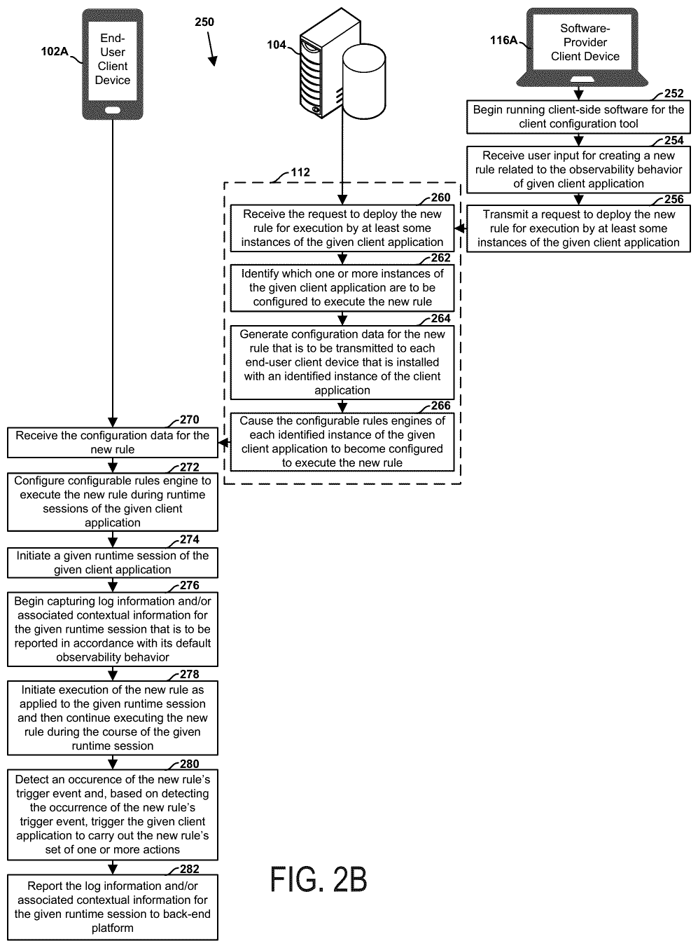

Turning now to FIGS. 2A-2B, flow diagrams 200 and 250 are provided that show some example operations that may be carried out in accordance with the present disclosure. For purposes of illustration only, the operations are described as being carried out by the example end-user client device 102A that is installed with an instance of the given client application, the example back-end platform 104, and the example software-provider client device 116A within the example network environments of FIGS. 2A-2B. It should be understood, however, that this functionality may be carried out by any of various other devices in any of various other network environments as well.

Beginning with FIG. 2A, the given client application installed on the end-user client device 102A may initially be configured to operate in accordance with its default observability behavior, which may comprise the observability behavior that is defined in the released version of the client application. This default observability behavior may involve (i) capturing and reporting a default scope of log information for runtime sessions (e.g., a default log level setting and perhaps other default settings related to the manner in which the given client application captures and reports log information) and perhaps also (ii) capturing and reporting a default scope of associated contextual information for runtime sessions (e.g., a default set of contextual attributes and perhaps other default settings related to the manner in which the given client application captures and reports contextual information), among other possible aspects of the given client application's default observability behavior.

To illustrate with an example, the given client application's default observability behavior may comprise (i) capturing and reporting log information in accordance with a default log level setting such as INFO so that log entries having a severity level of INFO or higher will be captured and reported by default by the given client application and (ii) capturing and reporting contextual information for a default set of contextual attributes that includes at least one attribute related to the state of the given client application (e.g., lifecycle state) or the client device running the given client application (e.g., network connection state). However, the given client application's default observability behavior may take any of various other forms as well.

At block 202, while operating in accordance with its default observability behavior, the given client application installed on the end-user client device 102A may capture a respective set of log information and/or associated contextual information for each of one or more runtime sessions. In this respect, the respective set of log information and/or associated contextual information that is captured for each runtime session may comprise the default scope of log information and default scope of contextual information that is defined as part of the given client application's default observability behavior.

In conjunction with capturing the respective set of log information and/or associated contextual information for a runtime session, the given client application may write the respective set of log information and/or associated contextual information to the local data storage of end-user client device 102A. For instance, after capturing each new log entry and/or each new snapshot of associated contextual information, the given client application may write the new log entry and/or the new snapshot of associated contextual information to the local data storage of end-user client device 102A. In accordance with the present disclosure, such log information and/or associated contextual information may be written to the client device's local data storage utilizing any of various storage architectures, including but not limited to the example storage architectures that are described below.

Additionally, prior to writing the respective set of log information and/or associated contextual information for a runtime session to the local data storage of end-user client device 102A, the given client application may optionally perform any of various types of pre-processing operations on the log information and/or associated contextual information for the runtime session, examples of which may include pre-processing operations such as validation, cleansing, deduplication, filtering, aggregation, summarization, enrichment, restructuring, reformatting, translation, and/or mapping, among others.

Turning next to block 204, while operating in accordance with its default observability behavior, the given client application installed on the end-user client device 102A may report the captured log information and/or associated contextual for the one or more runtime sessions to the back-end platform 104. This function may take various forms, and in at least some implementations, may involve (i) preparing the log information and contextual information for transmission to the back-end platform 104 (e.g., by retrieving the log information and/or contextual information from the local data storage of the end-user client device 102A and packaging it up into a message structure that is readable by the back-end platform 104) and then (ii) causing the respective set log information and/or contextual information for each of the one or more runtime sessions to be transmitted over the respective communication path between the end-user client device 102A and the back-end platform 104, which as noted above may include one or more data networks and/or data links.

In practice, the given client application may report the respective sets of log information and/or associated contextual information for the one or more runtime sessions of the given client application to the back-end platform 104 at any of various times. In one implementation, the given client application may be configured to report the respective set of log information and/or associated contextual information for a runtime session to the back-end platform 104 at the time that the runtime session of the given client application concludes (e.g., given client application may be configured to report a runtime session's respective set of log information and/or associated context information in response to determining that the runtime session has been terminated). In another implementation, the given client application may be configured such that, if a runtime session concludes at a time when the end-user client device 102A is only connected to a cellular network and not a Wi-Fi network, the given client application may wait to report the respective set of log information and/or associated contextual information for the runtime session to the back-end platform 104 until the end-user client device 102A re-connects to a Wi-Fi network in order to avoid utilizing cellular data to transmit the respective set of log information and/or associated contextual information for the runtime session-which could result in the end-user client device 102A sending respective sets of log information and/or associated contextual information for multiple runtime sessions that have taken place since the end-user client device's last connection to a Wi-Fi network. The given client application may report the respective sets of log information and/or associated contextual information for the one or more runtime sessions of the given client application to the back-end platform 104 at other times as well.

Further, while the given client application may be configured to report both log information and associated contextual information for a runtime session to the back-end platform 104, in some implementations, the log information and associated contextual information could be captured and maintained by the given client application as separate datasets. In such implementations, the given client application could be configured to report a runtime session's log information and contextual information to the back-end platform 104 either during a single communication session with the back-end platform 104 or over the course of multiple separate communication sessions with the back-end platform 104 (e.g., one session for the log information and one for the contextual information) that could take place at the same time or different times, among other possibilities as to the particular manner in which the log information and contextual information for a runtime session could be reported to the back-end platform 104.

Further yet, along with reporting the respective set of log information and/or associated contextual information for a runtime session to the back-end platform 104, the given client application may also report certain session details for the runtime session, such as a session ID, application information for the given client application (e.g., version information), device information for the end-user client device 102A on which the runtime session of the given client application occurred (e.g., brand, model, operating system version, etc.), and/or duration information for the runtime session, among other possibilities.

As shown at block 210, the integration pipeline 106 may then receive the log information and/or associated contextual information for the one or more runtime sessions (along with the corresponding session details) that was captured and reported by the given client application running on the end-user client device 102A in accordance with given client application's default observability behavior.

In turn, at block 212, the integration pipeline 106 may perform certain pre-processing operations on the received log information and/or contextual information for the one or more runtime sessions of the given client application. These pre-processing operations may take any of various forms.

As one possibility, the integration pipeline's pre-processing operations may involve any of various operations for preparing the log information and/or contextual information for further use by the back-end platform 104, including but not limited to operations such as validation, cleansing, deduplication, filtering, aggregation, summarization, enrichment, restructuring, reformatting, translation, and/or mapping, among others. As another possibility, if the log information and associated contextual information are received as separate datasets (e.g., in instances where the given client application captures and records the log information and the contextual information as separate data records), the integration pipeline's pre-processing operations may involve functionality for (i) identifying associations between log entries and snapshots of contextual information, and (ii) memorializing the identified associations between said log entries and snapshots of contextual information for later use. The integration pipeline's pre-processing operations may take other forms as well.

At block 214, the integration pipeline 106 may then write the respective set of log information and/or associated contextual information for each runtime session of the given client application to the session data store 110, so that the respective set of log information and/or associated contextual information for each runtime session of the given client application is available for future retrieval and use by the session analysis service 108 and perhaps also other functional systems of the given software provider's back-end platform 104. Additionally, along with the respective set of log information and/or contextual information for each runtime session of the given client application, the integration pipeline 106 may also write the received session details for each runtime session of the given client application (e.g., session ID, application information for the given client application, device information for the end-user client device 102 on which the respective runtime session of the given client application occurred, and/or duration information for the respective runtime session).

After the respective set of log information and/or associated contextual information for a runtime session has been written to the session data store 110, a user associated with the software provider (e.g., a developer, engineer, analyst, or the like) may be able to access and view information about the runtime session in order to facilitate the user's analysis of the runtime session. For instance, when a user associated with the software provider wishes to perform an analysis of a given runtime session of the given client application, the user may begin by launching a session analysis tool on a given software-provider client device 116 such as the software-provider client device 116A, which may cause the software-provider client device 116A to begin running client-side software for the launched session analysis tool. In practice, this client-side software for the session analysis tool may take the form of a mobile application, a web application, or a desktop application, among other possibilities, and may comprise a user interface that enables the user to view information about runtime sessions of the given client application.

As shown at block 220, while running client-side software for the launched session analysis tool, the software-provider client device 116A may then receive user input comprising a request by the user to view information about the given runtime session. This user input may take various forms, examples of which may include a user input of a Session ID for the given runtime session or a user selection of the given runtime session from a displayed list of available runtime sessions of the given client applications, among other possibilities.

Turning next to block 222 after receiving the user input comprising a request by the user to view information about the given runtime session, the software-provider client device 116A may transmit a request to the session analysis service 108 for information about the given runtime session of the given client application (e.g., a runtime session of the given client application that was captured by the end-user client device 102A) that is to be presented to the user of the software-provider client device 116A for review and analysis. In practice, this request may take the form of one or more request messages (e.g., one or more HTTP messages) that are sent over the respective communication path between the software-provider client device 116A and the back-end platform 104, and in at least some implementations, the one or more request messages may be sent via an Application Programming Interface (API). However, the software-provider client device's request may take other forms as well.

Further, the request for the information about the given runtime session of the given client application that is sent from the software-provider client device 116A to the back-end platform 104 may take various forms, and in at least some implementations, may include identifying information for the given runtime session of the given client application session (e.g., an application ID, a session ID, etc.) for which the information is being requested.

At block 230, the session analysis service 108 of the back-end platform 104 may then receive the request for the information about the given runtime session that was sent by the software-provider client device 116A.

In turn, at block 232, the session analysis service 108 may retrieve at least a portion of the respective set of log information and/or associated contextual information for the given runtime session of the given client application from the session data store 110 (perhaps along with the corresponding session details for the given runtime session). To accomplish this, the session analysis service 108 may utilize the identifying information for the given runtime session of the given client application that is included in the received request to locate the respective set of log information and/or associated contextual information for the given runtime session of the given client application that is stored within the session data store 110.

Then, at block 234, the session analysis service 108 may cause the software-provider client device 116A to present the retrieved log information and/or associated contextual information for the given runtime session of the given client application. To accomplish this, the session analysis service 108 may transmit a response to the software-provider client device 116A that comprises instructions and data for constructing a UI view that presents the information for the given runtime session of the given client application. In practice, this response may take the form of one or more response messages (e.g., one or more HTTP messages) that are sent over the respective communication path between the back-end platform 104 and the software-provider client device 116A, and in at least some implementations, the one or more response messages may be sent via an API. However, the session analysis service's response may take other forms as well.

At block 240, the software-provider client device 116A may receive the response from the session analysis service 108 and then present the retrieved log information and/or associated contextual information for the given runtime session of the given client application via a UI view displayed on the software-provider client device 116A, which may take any of various forms. Thereafter, the user of the software-provider client device 116A may then review and analyze the log information and/or associated contextual information for the given runtime session of the given client application that is presented via the UI view.

After the given client application has been released and the installed instances of the given client application installed have begun operating in accordance with the given client application's default observability behavior, the technology disclosed herein may then enable a user associated with the given software provider (e.g., a developer, engineer, analyst, or the like) to create a new rule related to the observability behavior of the given client application that is to be deployed for execution by at least some instances of the given client application, which could include the instances of the given client application installed on at least some of the end-user client devices 102 of FIG. 1. An example of this functionality with now be described with reference to FIG. 2B.

Beginning at block 252, when a user associated with the software provider wishes to create a new rule related to the observability behavior of the given client application that is to be deployed for execution by at least some instances of the given client application, the user may start by launching a client configuration tool on a given software-provider client device 116 such as the software-provider client device 116A, which may cause the software-provider client device 116A to begin running client-side software for the launched client configuration tool. In practice, this client-side software for the client configuration tool may take the form of a mobile application, a web application, or a desktop application, among other possibilities, and may comprise a user interface that enables the user to create a new rule related to the observability behavior of the given client application that is to be deployed for execution by at least some instances of the given client application. This user interface may enable the user to create a new rule related to the observability behavior of the given client application in any various ways. For instance, as one possibility, the user interface may guide the user through a workflow where the user is presented with one or more UI views that enable the user to provide user input specifying (i) a trigger event for the rule and (ii) a set of one or more actions for the rule. In this respect, the one or more UI views may comprise lists of user-selectable options (e.g., predefined types of trigger events and/or actions that are available for selection and/or predefined types of parameters that can be utilized to define a trigger event) and/or user-fillable fields (e.g., a field for specifying a value of a given parameter that defines a trigger event) that may be utilized by the user to specify the trigger event and the set of one or more actions for the rule, among other possibilities. As another possibility, the user interface may provide the user with an ability to input or upload structured configuration data that specifies the trigger event and the set of one or more actions for the new rule.

Additionally, along with enabling the user to provide user input specifying the trigger event and the set of one or more actions for the new rule, the user interface may enable the user to input identifying information for the new rule, such as a name of the new rule, a category of the new rule, and/or a brief description of the new rule, among other possibilities.

Additionally yet, along with enabling the user to provide user input specifying the trigger event and the set of one or more actions for the new rule, the user interface may optionally enable the user to input information indicating which particular instances of the given client application that are to be configured to execute the new rule. For example, the user interface may enable a user to input any of (i) identifying information for one or more specific instances of the given client application that are to be configured to execute the new rule (e.g., a unique identifier of a specific instance of the given client application and/or an end-user client device installed with a specific instance of the given client application), (ii) criteria for identifying instances of the given client application that are to be configured to execute the new rule, such as criteria regarding the geographical locations of the end-user client devices installed with instances of the given client application and/or criteria regarding the versions of the installed instances of the given client application, among other possibilities, or (iii) an indication that every installed instance of the given client application should be configured to execute the rule. However, the user may also forgo inputting information indicating which particular instances of the given client application that are to be configured to execute the new rule, in which case the back-end platform 104 may identify which instances of the given client application are to be configured to execute the new rule based on something other than user input.

The user interface for creating a new rule related to the observability behavior of the given client application may take other forms as well.

At block 254, while running the client-side software for the client configuration tool, the software-provider client device 116A may receive user input for creating a new rule related to the observability behavior of the given client application that comprises (i) a specified trigger event that is to cause a change in the observability behavior of the given client application if detected and (ii) a specified set of one or more actions related to the observability behavior of the given client application that is to be carried out when the trigger event is detected. In this respect, the specified trigger event and the specified set of one or more actions for the new rule may each take any of various forms, including but not limited to any of the forms previously described. Further, the user input for creating the new rule may take any of various forms, including but not limited to user input specifying the trigger event and the set of one or more actions for the rule, user input specifying identifying information for the new rule (e.g., name, category, brief description, etc.), and perhaps also user input specifying information indicating which particular instances of the given client application are to be configured to execute the new rule, among others.

One possible example of a user interface of the client-side software for the client configuration tool that enables a user of the client-side software for the client configuration tool to create a new rule related to the observability behavior of a given client application will now be described. In line with the discussion above, the example user interface (which may be presented by a client device such as software-provider client device 116A) may enable the user to input any of various types of user input for creating the new rule, including but not limited to user input specifying (i) a trigger event for the new rule, which may comprise a set of one or more conditions that may evaluate to true during a runtime session of the given client application, and (ii) a set of one or more actions for the new rule. And in order to accomplish this, the example user interface may enable the user to build the new rule by creating and interconnecting instances of at least two types of configurable user-interface (UI) elements: (i) a “condition” type of UI element that represents a trigger-event condition and (ii) an “action” type of UI element that represents an action for the rule.

The “condition” type of UI element may represent any of various different types of trigger-event conditions that may be included in a rule related to the observability behavior of the given client application.

For instance, the “condition” type of UI element may represent any of the various types of trigger-event conditions described above, including but not limited to trigger-event conditions related to (i) the log entries that are recorded by the given client application (e.g., recordation of a log entry of a particular type, a log entry containing a particular phrase, etc.), (ii) the state and/or operation of the given client application (e.g., particular changes in the given client application's state such as opening, launching, or closing the application, moving the application to the foreground or background, etc., and/or particular actions carried out by the given client application such as sending or receiving particular types of network messages), (iii) the state and/or operation of the client device running the given client application (e.g., particular changes in the client device's state such as a change in device's location, time zone, operating state, compute resource utilization, etc., and/or particular actions carried out by the client device such as sending or receiving particular types of network messages), (iv) the end-user input interaction with the given client application, and/or (v) sensor data that is captured by the client device running the given client application, among various other possibilities.

Further, the manner in which a user defines a trigger-event condition that is to be represented by an instance of the “condition” type of UI element may take various forms. For instance, for some trigger-event conditions, the client configuration tool may provide the user with an option to select a condition that is predefined within the client configuration tool (e.g., from a list of predefined trigger-event conditions). Some representative examples of these kinds of predefined conditions may include conditions that are based on the occurrence of certain predefined state changes of either the given client application or the client device (e.g., detecting that the application has been opened, launched, or closed, detecting that the device has changed location or time zone, etc.) and/or the performance of certain predefined actions by either the given client application or the client device (e.g., sending or receiving certain types of network messages), which the user can specify by simply selecting the predefined condition without the need to provide any other associated user input. Alternatively, for other trigger-event conditions, the client configuration tool may provide the user with an option to input a logical expression (e.g., a sequence of one or more logical operands and logical operators) that defines the trigger-event condition, which allows the universe of trigger-event conditions supported by the client configuration tool to be extended. Some representative examples of these kinds of user-defined conditions include (i) a logical expression that evaluates whether a particular numerical parameter related to the state and/or operation of either the given client application or the client device is greater than, less than, or equal to a numerical value and/or (ii) a logical expression that evaluates whether a particular numerical or textual parameter related to the state and/or operation of either the given client application or the client device matches or at least contains a particular value. Alternatively yet, for still other trigger-event conditions, the client configuration tool may provide the user with an option to use a programming language to define the trigger-event condition in terms of source code or the like, which similarly allows the universe of trigger-event conditions supported by the client configuration tool to be extended. The manner in which a user defines a trigger-event condition that is to be represented by an instance of the “condition” type of UI element may take other forms as well, including but not limited to the possibility that the user may define a trigger-event condition in terms of multiple sub-conditions (e.g., predefined conditions and/or logical expressions) that are connected by an “AND” or “OR” operator.

In addition to representing a trigger-event condition of a rule, the “condition” type of UI element may also optionally represent a filter on which particular instances of the given client application are to evaluate and apply the trigger-event condition once the rule is deployed, which may be referred to herein as a “client-instance filter” for a trigger-event condition. Such a client-instance filter may take any of various forms, examples of which may include a filter related to (i) the application version, build, etc. of the client-application instance, (ii) the operating system type or operating system version of the client device running the client-application instance, (iii) a type of network connection of the client device running the client-application instance (e.g., cellular versus Wi-Fi), (iv) the foreground/background state of the client-application instance, and/or (v) a location of the client device running the client-application instance.

To illustrate with one example, a user could define a client-instance filter specifying that a trigger-event condition represented by a given instance of the “condition” type of UI element is to be utilized by one particular version of the given client application, at the exclusion of other versions, and this filter may subsequently be utilized to determine which client-application instances are to evaluate and apply the trigger-event condition. Or to illustrate with another example, a user could define a client-instance filter specifying that a trigger-event condition represented by a given instance of the “condition” type of UI element is to be utilized by instances of the given client application running on client devices that are installed with a particular type and/or version of operating system (e.g., iOS versus Android), at the exclusion of types and/or versions of operating systems, and this filter may subsequently be utilized to determine which client-application instances are to evaluate and apply the trigger-event condition. Many other examples of client-instance filters are possible as well.

Further, the manner in which a user defines a client-instance filter that is to be represented by an instance of the “condition” type of UI element may take various forms. For instance, for some client-instance filters, the client configuration tool may provide the user with an option to select a filter that is predefined within the client configuration tool (e.g., from a list of predefined trigger-event conditions). Some representative examples of these kinds of predefined filters include filters that are based on the type of the client device's operating system (e.g., an “iOS” filter or an “Android” filter) or the foreground/background state of the client-application instance (e.g., a “Foreground” filter), which the user can specify by simply selecting the predefined filter without the need to provide any other associated user input. Alternatively, for other client-instance filters, the client configuration tool may provide the user with an option to input a logical expression that defines the client-instance filter, which may comprise a sequence of one or more logical operands and logical operators. Some representative examples of these kinds of user-defined filters include (i) a logical expression that evaluates whether a particular numerical parameter related to either the given client application or the client device (e.g., an application version number or operating system version number) is greater than, less than, or equal to a numerical value and/or (ii) a logical expression that evaluates whether a particular numerical or textual parameter related to either the given client application or the client device matches or at least contains a particular value (e.g., an application version number, operating system version number, network connection type identifier, etc.). Alternatively yet, for still other client-instance filters, the client configuration tool may provide the user with an option to use a programming language to define the client-instance filter in terms of source code or the like. The manner in which a user defines a client-instance filter to be represented by an instance of the “condition” type of UI element may take other forms as well, including but not limited to the possibility that the user may define a client-instance filter in terms of multiple sub-filters (e.g., predefined filters and/or logical expressions) that are connected by an “AND” or “OR” operator.

While the “condition” type of UI element may represent a client-instance filter for a trigger-event condition, it should be understood that this is an optional aspect of the “condition” type of UI element that need not be included in every instance of the “condition” type of UI element. In this respect, if a user creates a new instance of the “condition” type of UI element that represents a trigger-event condition for a rule and does not specify any client-instance filter for the trigger-event condition, then the default is that the trigger-event condition is to be evaluated and applied by all instances of the given client application to which the rule is deployed.

The “condition” type of UI element may represent other information related to a trigger-event condition of a rule as well. Further, in at least some implementations, the “condition” type of UI element may include a textual or graphical representation of at least a portion of the trigger-event condition and/or the client-instance filter that is represented by the “condition” type of UI element.

As noted above, another type of configurable UI element that may be utilized to build a new rule may comprise the “action” type of UI element, which may represent any of various different types of actions that may be included in a rule related to the observability behavior of the given client application. For instance, the “action” type of UI element may represent any of the various types of actions described above, including but not limited to (i) changing the behavior of the given client application as it relates to what type of data is captured, generated, stored, and/or reported in connection with runtime sessions of the given client application (e.g., by changing the scope of the log information and/or contextual information that is captured, generated, stored, and/or reported or by beginning to capture, generate, store, and/or an additional type of data such as additional log, contextual, or metric data), (ii) sending a network communication to another computing platform (e.g., a notification of a trigger event), (iii) initiating a communication session with another entity (e.g., a live support session or interactive debugging session with a software provider), and/or (iv) initiating an interaction with an end user of the client device running the given client application, among other possible types of actions that may be carried out by the given client application, the client device, and/or another computing platform in response to the occurrence of a trigger event.

Further, the manner in which a user defines an action that is to be represented by an instance of the “action” type of UI element may take various forms. For instance, for some actions, the client configuration tool may provide the user with an option to select an action that is predefined within the client configuration tool (e.g., from a list of predefined actions). Alternatively, for other actions, the client configuration tool may provide the user with an option to input a logical expression that defines the action (e.g., in terms of a function call or the like), which allows the universe of actions supported by the client configuration tool to be extended. Alternatively yet, for still other actions, the client configuration tool may provide the user with an option to use a programming language to define the action in terms of source code or the like, which similarly allows the universe of actions supported by the client configuration tool to be extended. The manner in which a user defines an action that is to be represented by an instance of the “action” type of UI element may take other forms as well, including but not limited to the possibility that the user may define an action in terms of multiple sub-actions (e.g., predefined actions and/or logical expressions) that are connected by an “AND” or “OR” operator.

In addition to representing an action of a rule, the “action” type of UI element may also optionally represent a filter on which particular instances of the given client application are to carry out the action once the rule is deployed, which may be referred to herein as a “client-instance filter” for an action. Such a client-instance filter may take any of various forms, including but not limited to any of the example forms of client-instance filters discussed above in connection with the trigger-event conditions.

To illustrate with one example, a user could define a client-instance filter specifying that an action represented by a given instance of the “action” type of UI element is to be utilized by one particular version of the given client application, at the exclusion of other versions, and this filter may subsequently be utilized to determine which client-application instances are to carry out the action responsive to occurrences of the rule's trigger event. Or to illustrate with another example, a user could define a client-instance filter specifying that an action represented by a given instance of the “action” type of UI element is to be utilized by instances of the given client application running on client devices that are installed with a particular type and/or version of operating system (e.g., iOS versus Android), at the exclusion of types and/or versions of operating systems, and this filter may subsequently be utilized to determine which client-application instances are to carry out the action responsive to occurrences of the rule's trigger event. Many other examples of client-instance filters are possible as well.

Further, the manner in which a user defines a client-instance filter that is to be represented by an instance of the “action” type of UI element may take various forms. For instance, for some of client-instance filters, the client configuration tool may provide the user with an option to select a filter that is predefined within the client configuration tool (e.g., from a list of predefined trigger-event conditions). Some representative examples of these kinds of predefined filters include filters that are based on the type of the client device's operating system (e.g., an “iOS” filter or an “Android” filter) or the foreground/background state of the client-application instance (e.g., a “Foreground” filter), which the user can specify by simply selecting the predefined filter without the need to provide any other associated user input. Alternatively, for other client-instance filters, the client configuration tool may provide the user with an option to input a logical expression that defines the client-instance filter, which may comprise a sequence of one or more logical operands and logical operators. Some representative examples of these kinds of user-defined filters include (i) a logical expression that evaluates whether a particular numerical parameter related to either the given client application or the client device (e.g., an application version number or operating system version number) is greater than, less than, or equal to a numerical value and/or (ii) a logical expression that evaluates whether a particular numerical or textual parameter related to either the given client application or the client device matches or at least contains a particular value (e.g., an application version number, operating system version number, network connection type identifier, etc.). Alternatively yet, for still other client-instance filters, the client configuration tool may provide the user with an option to use a programming language to define the client-instance filter in terms of source code or the like. The manner in which a user defines a client-instance filter to be represented by an instance of the “action” type of UI element may take other forms as well, including but not limited to the possibility that the user may define a client-instance filter in terms of multiple sub-filters (e.g., predefined filters and/or logical expressions) that are connected by an “AND” or “OR” operator.

While the “action” type of UI element may represent a client-instance filter for an action, it should be understood that this is an optional aspect of the “action” type of UI element that need not be included in every instance of the “action” type of UI element. In this respect, if a user creates a new instance of the “action” type of UI element that represents an action for a rule and does not specify any client-instance filter for the action, then the default is that the action is to be carried out by all instances of the given client application to which the rule is deployed.

The “action” type of UI element may represent other information related to a trigger-event condition of a rule as well. Further, in at least some implementations, the “action” type of UI element may include a textual or graphical representation of at least a portion of the action and/or the client-instance filter that is represented by the “action” type of UI element.

As noted above, the example user interface may enable a user to build a new rule by creating and interconnecting instances of the “condition” and “action” types of UI elements. In practice, such a rule may be built from a first set of one or more instances of the “condition” type of UI element and a second set of one or more instances of the “action” type of UI element, where there is at least one interconnection between the instances of the “condition” and “action” types of UI elements to represent the logical relationship between the one or more trigger-event conditions and the one or more actions of the rule (e.g., an if-then relationship reflecting that an action is the functional consequence of at least one condition evaluating to true). The functionality provided by the example user interface for building a new rule may take any of various forms.

According to one possible implementation, the process for creating a new rule may begin with a user inputting a request to create the new rule, which may prompt the client-side software for the client configuration tool to present the user with a UI view that includes a “rule creation” workspace along with (i) at least one selectable option for creating a new instance of the “condition” type of UI element and (ii) at least one selectable option for creating a new instance of the “action” type of UI element. Using this UI view, the user may build a new rule comprising any of various different combinations of trigger-event conditions and actions by creating, arranging, and interconnecting instances of the “condition” and “action” types of UI elements. In this respect, each instance of a “condition” type of UI element may be interconnected with one or more other instances of a “condition” type of UI element, one or more instances of an “action” type of UI element, or a combination of both types of UI elements. And likewise, each instance of an “action” type of UI element may be interconnected with one or more instances of a “condition” type of UI element, one or more other instances of an “action” type of UI element, or a combination of both types of UI elements. To facilitate this functionality, the UI view may present selectable “connect” icons that may be attached to instances of the “condition” type of UI element, instances of the “action” type of UI element, or both. These selectable “connect” icons may be utilized define the interconnections between instances of UI elements.

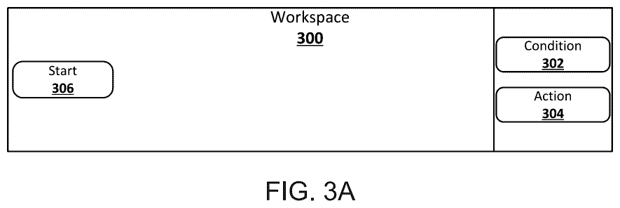

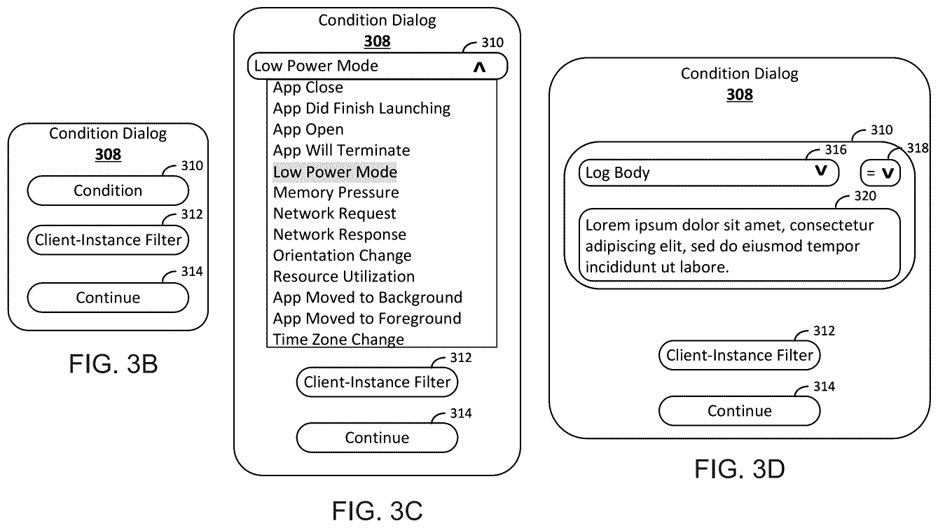

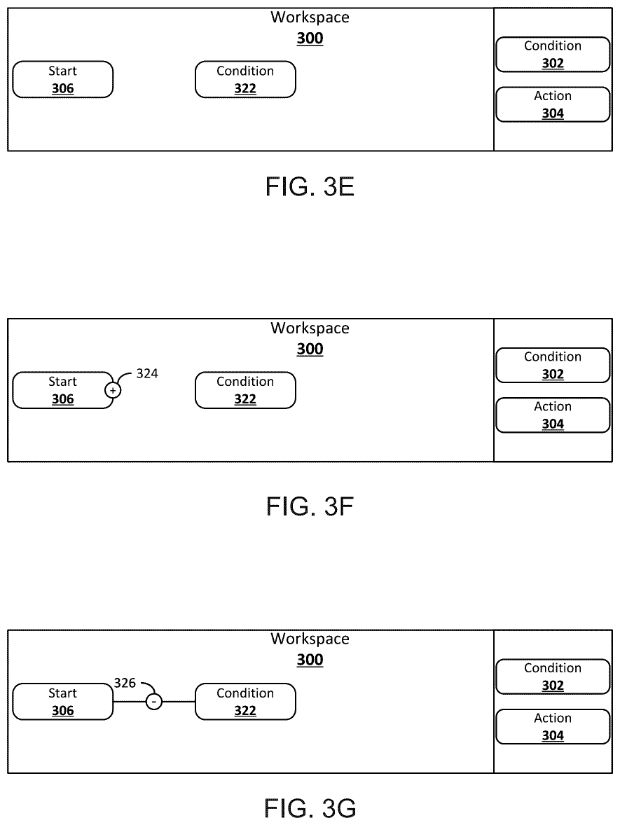

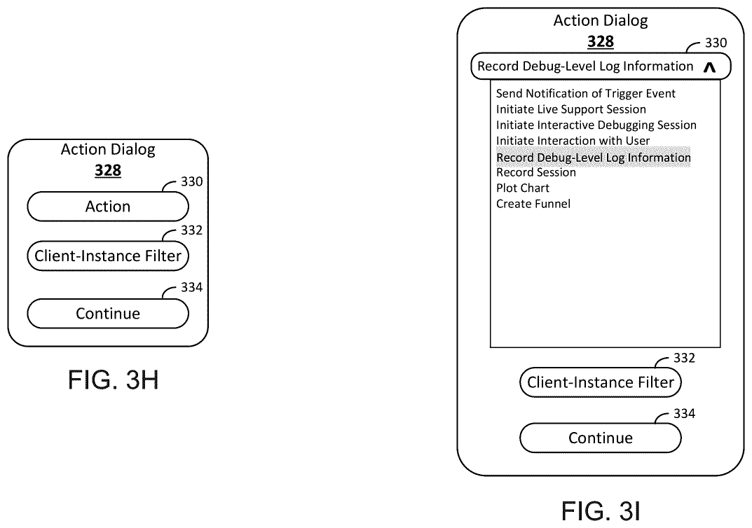

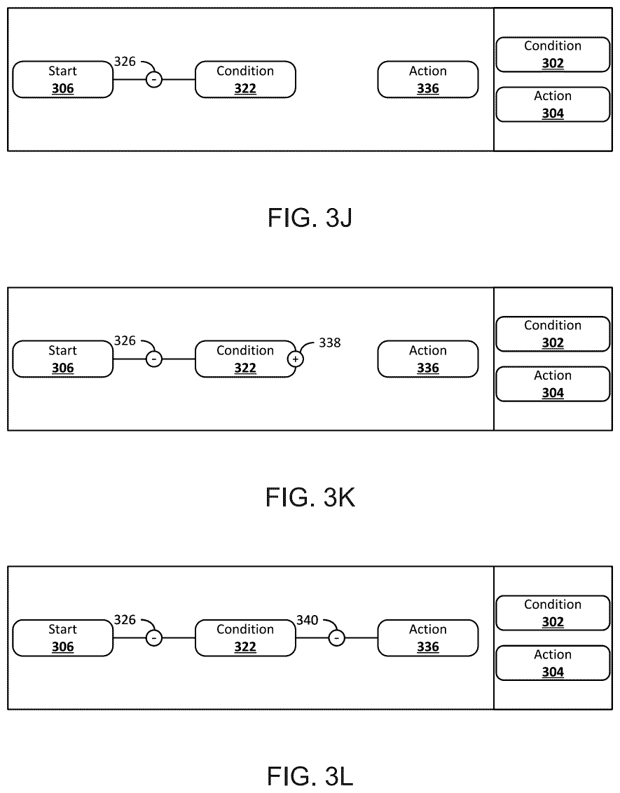

To further illustrate the functionality of the disclosed user interface for building a new rule, FIGS. 3A-3L show a first example scenario in which a user utilizes the type of UI view described above to build a new rule comprising a single trigger-event condition and a single action. It should be understood that the functions described below may be carried out by the software-provider client device 116A or any other client device that is capable of running the client-side software for the client configuration tool.

Beginning with FIG. 3A, the UI view is shown to include a “rule creation” workspace 300 along with (i) a first selectable icon 302 for creating a new instance of the “condition” type of UI element and (ii) a second selectable icon 304 for creating a new instance of the “action” type of UI element. In the example UI view of FIG. 3A, the selectable icons 302 and 304 are presented within a side panel that sits to the right of the “rule creation” workspace 300, but it should be understood that the selectable icons 302 and 304 could be presented in other manners as well. Further, as shown in FIG. 3A, the “rule creation” workspace 300 may optionally include a “start” UI element 306, which may serve as a starting point from which instances of the “condition” type of UI element and of the “action” type of UI element may be interconnected to create the new rule.

To add a new instance of the “condition” type of UI element to the “rule creation” workspace 300 using the example UI view shown in FIG. 3A, the user may either (i) click and release the selectable “condition” icon 302, which may cause the client-side software for the client configuration tool to create a new draft instance of the “condition” type of UI element and automatically position it somewhere within the “rule creation” workspace 300 (e.g., to a blank space within the “rule creation” workspace 300) or (ii) click the selectable “condition” icon 302, drag it to a position within the “rule creation” workspace 300, and then release it, which may cause the client-side software for the client configuration tool to create a new draft instance of the “condition” type of UI element at that position. Various other possibilities may also exist.

Either before or after the new draft instance of the “condition” type of UI element has been positioned within the “rule creation” workspace 300, the client-side software for the client configuration tool may present the user with a dialog for defining the trigger-event condition that is to be represented by the new draft instance of the “condition” type of UI element. For instance, the client-side software for the client configuration tool may present the user with such a dialog (i) when the user clicks the selectable “condition” icon 302, (ii) when the user drags the selectable “condition” icon 302 to a position within the “rule creation” workspace 300 and then releases it, and/or (iii) when the user interacts with the draft instance of the “condition” type of UI element after it has been positioned within the “rule creation” workspace 300 (e.g., by clicking the draft instance, hovering over the draft instance, or clicking a settings icon or the like that may be attached to the draft instance, etc.), among other possibilities.

FIG. 3B shows one example of the dialog that may be presented to the user for defining the trigger-event condition that is to be represented by the new draft instance of the “condition” type of UI element, which is shown as “condition” dialog 308. As shown, the “condition” dialog 308 includes a first portion 310 for defining the trigger-event condition of the new draft instance of the “condition” type of UI element. The first portion 310 may take any of various forms, including (i) a dropdown list of predefined condition options that can be selected by the user and/or (ii) a set of one or more input fields for defining the trigger-event condition in the form of a logical expression, among other possibilities. Further, in some implementations, the first portion 310 may enable the user to define the trigger-event condition in terms of multiple sub-conditions that are interconnected by at least one “AND” or “OR” operator such as by presenting (i) multiple dropdown lists of predefined condition options, (ii) multiple sets of one or more input fields for defining logical expressions, or (iii) a combination of at least one dropdown list of predefined condition options and at least one set of one or more input fields for defining a logical expression. The first portion 310 may take other forms as well.

To define the trigger-event condition that is to be represented by the new draft instance of the “condition” type of UI element, the user may interact with the first portion 310 of the “condition” dialog 308 (e.g., by selecting a predefined condition option from a dropdown list of predefined condition options and/or by defining a logical expression via a set of input fields).

As shown in FIG. 3B, the “condition” dialog 308 also includes a second portion 312 for defining a client-instance filter for the trigger-event condition. The second portion 312 may take any of various forms, including (i) a dropdown list of predefined filter options that can be selected by the user and (ii) a set of one or more input fields for defining the filter in the form of a logical expression, among other possibilities. Further, in some implementations, the second portion 312 may enable the user to define the client-instance filter in terms of multiple sub-filters that are interconnected by at least one “AND” or “OR” operator, such as by presenting (i) multiple dropdown lists of predefined filter options, (ii) multiple sets of one or more input fields for defining logical expressions, or (iii) a combination of at least one dropdown list of predefined filter options and at least set of one or more input fields for defining a logical expression. The second portion 312 may take other forms as well.

To define the client-instance filter for the trigger-event condition, the user may interact with the second portion 312 (e.g., by selecting a predefined filter option from a list of predefined filter options and/or by defining a logical expression via a set of one or more input fields).

As further shown in FIG. 3B, the “condition” dialog 308 includes a selectable “continue” button 314 for confirming the user input that is provided via the first and second portions 310 and 312. After the user selects the “continue” button 314, the client-side software for the client configuration tool may configure the new instance of the “condition” type of UI element based on the user input provided via the first and second portions 310 and 312. However, in line with the previous discussion, if the user does not specify any client-instance filter for the trigger-event condition, then the new instance of the “condition” type of UI element may not have any client-instance filter.

In line with the discussion above, FIG. 3C shows one example of the “condition” dialog 308 in a scenario where the first portion 310 comprises a dropdown list of predefined condition options that can be selected by the user. As shown in FIG. 3C, the dropdown list may include any of various types of predefined condition options, examples of which include: (i) an “App Close” condition, which may evaluate to true when the given client application has been closed, (ii) an “App Did Finish Launching” condition, which may evaluate to true when the given client application has finished launching, (iii) an “App Open” condition, which may evaluate to true when the given client application has been opened, (iv) an “App Will Terminate” condition, which may evaluate to true when there is an indication that the given client application is about to terminate, (v) a “Low Power Mode” condition, which may evaluate to true when the client device running the given client application enters a low power mode, (vi) a “Memory Pressure” condition, which may evaluate to true when an extent of memory pressure of the client device running the given client application falls below a predefined threshold, (vii) a “Network Request” condition, which may evaluate to true when the given client application or the client device sends and/or receives a network request message, (viii) a “Network Response” condition, which may evaluate to true when the given client application or the client device sends and/or receives a network response message, (ix) an “Orientation Change” condition, which may evaluate to true when the client device changes orientation, (x) a “Resource Utilization” condition, which may evaluate to true when an extent of resources being used by the client device to run the given client application exceeds a predefined threshold, (xi) an “App Moved to Background” condition, which may be evaluate to true when the given client application enters the background, (xii) an “App Moved to Foreground” condition, which may evaluate to true when the given client application enters the foreground, and (xii) a “Time Zone Change” condition, which may evaluate to true when the client device running the given client application changes time zones. The dropdown list of predefined condition options may take various other forms as well, including but not limited to the possibility that the dropdown list may include more or fewer predefined condition options than what is shown in FIG. 3C.

Using the dropdown list of predefined condition options shown in FIG. 3C, the user may select a predefined condition in order to define the trigger-event condition that is to be represented by the new instance of the “condition” type of UI element. In the example that is shown in FIG. 3C, the user has selected the “Low Power Mode” predefined condition.

In line with the discussion above, FIG. 3D shows another example of the “condition” dialog 308 in a scenario where the first portion 310 comprises a set of one or more input fields for defining the trigger-event condition in the form of a logical expression.

As shown in FIG. 3D, the set of one or more input fields includes a first input field 316 for inputting a first logical operand of the logical expression, which may take any of various forms. For instance, the first input field 316 is shown to take the form of a dropdown list of logical operand options, which may include certain numerical and/or textual parameters related to the state and/or operation of either the given client application or the client device that can be selected by the user. Using the first input field 316, the user may select a given parameter that is to be evaluated as part of the logical expression. In the example that is shown in FIG. 3D the user has selected a “Log Body” parameter as the given parameter that is to be evaluated as part of the logical expression. The first input field 316 may take other forms as well, including but not limited to the possibility that the first input field 316 may comprise an alphanumeric input field rather than a dropdown list.

Further, as shown in FIG. 3D, the set of one or more input fields includes a second input field 318 for inputting a comparison operator for the logical expression, which may take any of various forms. For instance, the second input field 318 is shown to take the form of a dropdown list of predefined logical operator options, which may include comparison operators such as greater than, greater than or equal to, less than, less than or equal to, equal to, contains, and/or starts with, among other possibilities. Using the second input field 318, the user may select a given comparison operator that is to define the relationship between the two logical operands of the logical expression. In the example that is shown in FIG. 3D, the user has selected a “=” comparison operator to use between the two logical operands of the logical expression, which means that the logical expression will evaluate to true when the first logical operand is equal to the second logical operand. The second input field 318 may take other forms as well, including but not limited to the possibility that the second input field 318 may comprise an alphanumeric input field rather than a dropdown list.

Further yet, as shown, the set of one or more input fields includes a third input field 320 for inputting a second logical operand of the logical expression, which may take any of various forms. For instance, the third input field 320 is shown to take the form of an alphanumeric input field where the user may input a textual and/or numerical value against which the given parameter may be evaluated. In this respect, the form of the user input entered into the third input field 320 may vary depending on the first logical operand that is input via the first input field 316 (and perhaps also the comparison operator that is input via the second input field 318). Using the third input field 320, the user may input a textual and/or numerical value against which the given parameter may be evaluated. For instance, in the example that is shown in FIG. 3D the user has input a textual phrase via the third input field 320, which means that the logical expression will evaluate to true when the “Log Body” parameter is equal to the textual phrase input via the third input field 320. The third input field 320 may take other forms as well.

While not shown in FIG. 3D, in some implementations, the set of one or more input fields for defining the logical expression may enable the user to define a logical expression that includes more than two logical operands and/or more than one logical operator. In such implementations, the set of one or more input fields may include additional input fields for defining additional logical operands and/or logical operators.

It should be understood that the first portion 310 of the “condition” dialog 308 may also include a combination of both a dropdown list of predefined condition options (such as the one shown in FIG. 3C) and a set of one or more input fields for defining a logical expression (such as the one shown in FIG. 3D), among other possible forms of the first portion 310 of the “condition” dialog 308. Further, it should be understood that the second portion 312 of the “condition” dialog 308 for defining a client-instance filter could include a dropdown list and/or a set of one or more input fields that are similar in nature to the dropdown list of FIG. 3C and/or the set of one or more input fields of FIG. 3D.

After the user has defined the trigger-event condition using the “condition” dialog 308, the new instance of the “condition” type of UI element positioned within the “rule creation” workspace 300 may transition from a draft state to a final state in which the instance of the “condition” type of UI element represents the trigger-event condition defined by the user.

FIG. 3E shows one example of how the UI view may look after the new instance of the “condition” type of UI element has been added to the “rule creation” workspace 300 and configured to represent the trigger-event condition defined by the user, where the new instance of the “condition” type of UI element is shown as “condition” UI element 322.

After the “condition” UI element 322 has been added to the “rule creation” workspace 300 and configured to represent the trigger-event condition defined by the user, the “condition” UI element 322 may then be interconnected with one or more other UI elements included in the “rule creation” workspace 300 so as to define a logical relationship between the trigger-event condition represented by the “condition” UI element 322 and the other elements of the new rule. For instance, in the example shown in FIG. 3E, the “condition” UI element 322 may be interconnected with the “start” UI element 306 to represent that the trigger-event condition represented by the “condition” UI element 322 is the first trigger-event condition to be evaluated after execution of the new rule starts.

To facilitate this functionality, the UI view may present a selectable “connect” icon attached to the “start” UI element 306, a selectable “connect” icon attached to the “condition” UI element 322, or both, where each such “connect” icon may either be presented persistently by the UI view or may be presented when the user interacts with a UI element (e.g., by hovering over the UI element, clicking the UI element, or the like). For instance, FIG. 3F shows how the UI view may look in an example where a selectable “connect” icon 324 for the “start” UI element 306 is being presented, e.g., in response to detecting that the user is interacting with the “start” UI element 306 in some way.

The user may then utilize the “connect” icon 324 to interconnect the “start” UI element 306 with the “condition” UI element 322, which may involve the user either (i) clicking and releasing the selectable “connect” icon 324 and then clicking and releasing the “condition” UI element 322 to define the interconnection between the two UI elements or (ii) clicking the selectable “connect” icon 324, dragging to the “condition” UI element 322, and then releasing to define the interconnection between the two UI elements. The function of interconnecting the “start” UI element 306 with the “condition” UI element 322 may take other forms as well.

FIG. 3G shows how the UI view may look after the user has interconnected the “start” UI element 306 with the “condition” UI element 322 using this functionality. As shown in FIG. 3G, an interconnection line is shown between the “start” UI element 306 and the “condition” UI element 322 to represent that they are interconnected, and there is also a selectable “disconnect” icon 326 presented in the middle of that line, which could be used to disconnect the “start” UI element 306 from the “condition” UI element 322 if desired (e.g., if the user wishes to remove the “condition” UI element 322 and replace it with a different “condition” UI element).

After interconnecting the “start” UI element 306 with the “condition” UI element 322, the user may next add a new instance of the “action” type of UI element to the “rule creation” workspace 300 using the example UI view. To do so, the user may either (i) click and release the selectable “action” icon 304, which may cause the client-side software for the client configuration tool to create a new draft instance of the “action” type of UI element and automatically position it somewhere within the “rule creation” workspace 300 (e.g., to a blank space within the “rule creation” workspace 300) or (ii) click the selectable “action” icon 304, drag it to a position within the “rule creation” workspace 300, and then release it, which may cause the client-side software for the client configuration tool to create a new draft instance of the “action” type of UI element at that position. Various other possibilities may also exist.

Either before or after the new draft instance of the “action” type of UI element has been positioned within the “rule creation” workspace 300, the client-side software for the client configuration tool may present the user with a dialog for defining the action that is to be represented by the new draft instance of the “action” type of UI element. For instance, the client-side software for the client configuration tool may present the user with such a dialog (i) when the user clicks the selectable “action” icon 304, (ii) when the user drags the selectable “action” icon 304 to a position within the “rule creation” workspace 300 and then releases it, and/or (iii) when the user interacts with the draft instance of the “action” type of UI element after it has been positioned within the “rule creation” workspace 300 (e.g., by clicking the draft instance, hovering over the draft instance, or clicking a settings icon or the like that may be attached to the draft instance, etc.), among other possibilities.

FIG. 3H shows one example of the dialog that may be presented to the user for defining the action that is to be represented by the new draft instance of the “action” type of UI element, which is shown as “action” dialog 328. As shown, the “action” dialog 328 includes a first portion 330 for defining the action of the new draft instance of the “action” type of UI element. The first portion 330 may take any of various forms, including (i) a dropdown list of predefined options that can be selected by the user and/or (ii) a set of one or more input fields for defining the action in the form of a logical expression (e.g., a function call), among other possibilities. Further, in some implementations, the first portion 330 may enable the user to define the action in terms of multiple sub-actions that are interconnected by at least one “AND” or “OR” operator such as by presenting (i) multiple dropdown lists of predefined action options, (ii) multiple sets of one or more input fields for defining logical expressions, or (iii) a combination of at least one dropdown list of predefined action options and at least one set of one or more input fields for defining a logical expression. The first portion 330 may take other forms as well

To define the action that is to be represented by the new draft instance of the “action” type of UI element, the user may interact with the first portion 330 of the “action” dialog 328 (e.g., by selecting a predefined action option from a dropdown list of predefined action options and/or by defining a logical expression via a set of input fields).

As shown in FIG. 3H, the “action” dialog 328 also includes a second portion 332 for defining a client-instance filter for the action. The second portion 332 may take any of various forms, including (i) a dropdown list of predefined filter options that can be selected by the user and (ii) a set of one or more input fields for defining the filter in the form of a logical expression, among other possibilities. Further, in some implementations, the second portion 332 may enable the user to define the client-instance filter in terms of multiple sub-filters that are interconnected by at least one “AND” or “OR” operator, such as by presenting (i) multiple dropdown lists of predefined filter options, (ii) multiple sets of one or more input fields for defining logical expressions, or (iii) a combination of at least one dropdown list of predefined filter options and at least one set of one or more input fields for defining a logical expression. The second portion 332 may take other forms as well.

To define the client-instance filter for the action, the user may interact with the second portion 332 (e.g., by selecting a predefined filter option from a list of predefined filter options and/or by defining a logical expression via a set of one or more input fields).

As further shown in FIG. 3H, the “action” dialog 328 includes a selectable “continue” button 334 for confirming the user input that is provided via the first and second portions 330 and 332. After the user selects the “continue” button 334, the client-side software for the client configuration tool may configure the new instance of the “action” type of UI element based on the user input provided via the first and second portions 330 and 332. However, in line with the previous discussion, if the user does not specify any client-instance filter for the action, then the new instance of the “action” type of UI element may not have any client-instance filter.

In line with the discussion above, FIG. 3I shows one example of the “action” dialog 328 in a scenario where the first portion 330 comprises a dropdown list of predefined condition options that can be selected by the users. As shown in FIG. 3I, the dropdown list may include any of various types of predefined action options, examples of which include: (i) a “Send Notification of Trigger Event” action, which may trigger the given client application to send a notification that one or more trigger-event conditions have evaluated to true to the software provider's back-end platform, (ii) an “Initiate Live Support Session” action, which may trigger the given client application to transmit a request to initiate a live support session to the software provider's back-end platform, (iii) an “Initiate Interactive Debugging Session” action, which may trigger the given client application to transmit a request to initiate an interactive debugging session to the software provider's back-end platform, (iv) an “Initiate Interaction with User” action, which may trigger the given client application to prompt an end user of the given client application to provide some input related to the observability behavior of the given client application, (v) a “Record Debug-Level Log Information” action, which may trigger the given client application to begin recording debug-level log information, (vi) a “Record Session” action, which may trigger the given client application to capture (or continue to capture) and report log information and/or contextual information for a runtime session, (vii) a “Plot Chart” action, which may trigger the given client application to generate (or continue to generate) and report data that can be utilized to generate a plot chart, such as time-series data for an individual or synthetic metric (e.g., a metric indicating how many times a given type of log event occurs during a runtime session of the given client application), and (viii) a “Create Funnel” action, which may trigger the given client application to generate (or continue to generate) and report data that can be utilized to generate a funnel-type visualization, such as data indicating counts of user interactions at different points within the given client application. The dropdown list of predefined action options may take various other forms as well, including but not limited to the possibility that the dropdown list may include more or fewer predefined action options than what is shown in FIG. 3I.

Using the dropdown list of predefined action options shown in FIG. 3I, the user may select a predefined action in order to define the action that is to be represented by the new instance of the “action” type of UI element. In the example that is shown in FIG. 3I, the user has selected the “Record Debug-Level Log Information” predefined action.

As another example, the first portion 330 may comprise a set of one or more input fields for defining the action in the form of a logical expression, such as a function call or the like.

It should be understood that the first portion 330 of the “action” dialog 328 may also include a combination of both a dropdown list of predefined action options (such as the one shown in FIG. 3I) and a set of one or more input fields for defining a logical expression, among other possible forms of the first portion 330 of the “action” dialog 328. Further, it should be understood that the second portion 332 of the “action” dialog 328 for defining a client instance filter could include a dropdown list similar in nature to the dropdown list of FIG. 3I and/or a set of one or more input fields.

After the user has defined the action using the “action” dialog 328, the new instance of the “action” type of UI element positioned within the “rule creation” workspace 300 may transition from a draft state to a final state in which the instance of the “action” type of UI element represents the action defined by the user.

FIG. 3J shows one example of how the UI view may look after the new instance of the “action” type of UI element has been added to the “rule creation” workspace 300 and configured to represent the action defined by the user, where the new instance of the “action” type of UI element is shown as “action” UI element 336.

After the “action” UI element 336 has been added to the “rule creation” workspace 300 and configured to represent the action defined by the user, the “action” UI element 336 may then be interconnected with one or more other UI elements included in the “rule creation” workspace 300 so as to define a logical relationship between the action represented by the “action” UI element 336 and the other elements of the new rule. For instance, in the example shown in FIG. 3J, the “action” UI element 336 may be interconnected with the “condition” UI element 322 to represent the logical relationship between the trigger-event condition represented by the “condition” UI element 322 and the action represented by the “action” UI element 336—namely, that if the trigger-event condition represented by the “condition” UI element 322 evaluates to true, then the action represented by the “action” UI element 336 is to be carried out as a functional consequence.

To facilitate this functionality, the UI view may present a respective selectable “connect” icon attached to one or more of the UI elements shown in the “rule creation” workspace 300, where each such “connect” icon may either be presented persistently by the UI view or may be presented when the user interacts with a UI element (e.g., by hovering over the UI element, clicking the UI element, or the like). For instance, FIG. 3K shows how the UI view may look in an example where a selectable “connect” icon 338 for the “condition” UI element 322 is being presented, e.g., in response to detecting that the user is interacting with the “condition” UI element 322 in some way.

The user may then utilize the “connect” icon 338 to interconnect the “condition” UI element 322 with the “action” UI element 336, which may involve the user either (i) clicking and releasing the selectable “connect” icon 338 and then clicking and releasing the “action” UI element 336 to define the interconnection between the two UI elements or (ii) clicking the selectable “connect” icon 338, dragging to the “action” UI element 336, and then releasing to define the interconnection between the two UI elements. The function of interconnecting the two UI elements may take other forms as well.

FIG. 3L shows how the UI view may look after the user has interconnected the “condition” UI element 322 with the “action” UI element 336 using this functionality. As shown in FIG. 3L, an interconnection line is shown between the “condition” UI element 322 and the “action” UI element 336 to represent that they are interconnected, and there is also a selectable “disconnect” icon 340 presented in the middle of that line, which could be used to disconnect the “condition” UI element 322 from the “action” UI element 336 if desired (e.g., if the user wishes to remove the “action” UI element 336 and replace it with a different “action” UI element).

It should be understood that the UI view may take various other forms as well. For instance, while the example UI view referenced in FIGS. 3A-3L includes a single selectable “condition” icon 302 and a single selectable “action” icon 304, other example UI views may include multiple different selectable “condition” icons and/or multiple different selectable “action” icons. For example, in addition to or instead of the selectable “condition” icon 302 and the selectable “action” icon 304, an example UI view may include (e.g., within a side panel) selectable icons for creating instances of certain types of predefined conditions and/or predefined actions. In such an example, a user selection of such an icon may cause the client-side software for the client configuration tool to add a new instance of a “condition” type of UI element representing a given predefined condition and/or a new instance of an “action” type of UI element representing a given predefined action to the “rule creation” workspace 300. Various other examples may also exist.

As previously mentioned, FIGS. 3A-3L describe a first example scenario in which a user utilizes the type of UI view described above to build a new rule comprising a single trigger-event condition and a single action. In line with the discussion above, the UI view may also enable a user to create rules that include any number of trigger-event conditions and/or actions. In this respect, additional trigger-event conditions and/or actions may be added to the rule by creating and interconnecting instances of “condition” and/or “action” UI elements in a similar manner to how the instances of “condition” and “action” UI elements shown in FIGS. 3A-3L are created and interconnected.

For instance, for each additional trigger-event condition and/or action to be added to a rule, a new instance of a “condition” UI element and/or “action” UI element may be added to the “rule creation” workspace, configured via a “condition” or “action” dialog, and interconnected to one or more other UI elements. However, in some implementations, the trigger-event conditions and/or actions that can be added to a rule may be limited to some extent by the trigger-event conditions and/or actions that were previously added to the rule, in which case the dialog for defining a later-added UI element may impose certain limitations on which trigger-event types of conditions and/or actions can be represented by the later-added UI element. For instance, if the user goes to define an additional trigger-event condition and/or action by selecting a predefined condition and/or action from a dropdown list (e.g., as in the examples shown in FIG. 3C and FIG. 3I), then the set of predefined conditions and/or actions shown to the user may not include certain predefined conditions and/or actions that are inconsistent with a trigger-event condition and/or action that was previously added to the rule. To illustrate with one example, if a previously-added trigger-event condition is an “App Moved to Foreground” trigger-event condition, then the set of predefined conditions shown to the user for defining an additional trigger-event condition may not include an “App Moved to Background” predefined condition because these conditions are mutually exclusive and cannot both evaluate to true. To illustrate with another example, if a client-instance filter for a previously-added action specifies that iOS client devices are to utilize the previously-added action, then the set of predefined actions shown to the user for defining an additional action may only include predefined actions that apply to iOS client devices because other non-iOS actions would be inconsistent with the previously-added action. Various other examples may also exist.

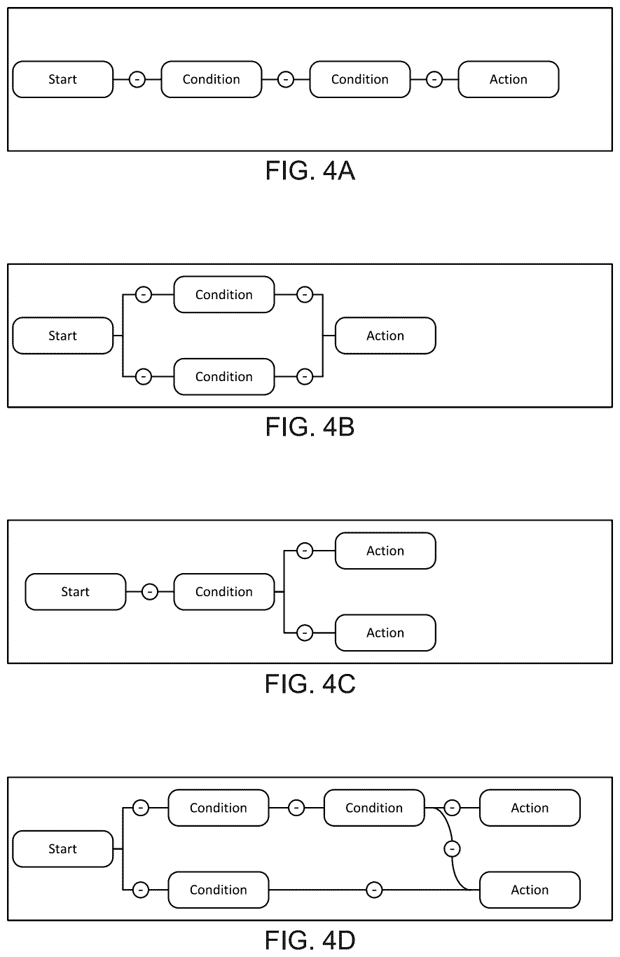

To illustrate with examples, FIGS. 4A-4D show how the type of UI view described above can be utilized to build rules comprising other combinations of trigger-event conditions and/or actions. It should be understood that the functions described below may be carried out by the software-provider client device 116A or any other client device that is capable of running the client-side software for the client configuration tool.

For instance, FIG. 4A shows a second example scenario in which a user utilizes the type of UI view described above to build a new rule comprising a trigger event having two trigger-event conditions and an action, where the action is to be carried out in response to both of the trigger-event conditions evaluating to true (i.e., the two trigger-event conditions are logically connected by an “AND” operator).

As shown, in this second example scenario, the “rule creation” workspace had been updated to include a first “condition” UI element that represents a first trigger-event condition, a second “condition” UI element that represents a second trigger-event condition, and an “action” UI element that represents an action, each of which may be created in a similar manner to the instances of “condition” and “action” UI elements described above. In particular, each such UI instance may be added to the “rule creation” workspace and configured via a “condition” or “action” dialog so as to represent a trigger-event condition or action defined by the user.

Further, as shown, the first “condition” UI element is interconnected with the second “condition” UI element via a first interconnection line and the second “condition” UI element is then interconnected with the “action” UI element via a second interconnection line, which represents that the trigger event for the new rule comprises two trigger-event conditions that must both evaluate to true before the action is to be carried out. In this respect, execution of the new rule represented by the arrangement of UI elements shown in FIG. 4A may involve (i) determining whether the first and second trigger-event conditions both evaluate to true, and (ii) in response to a determination that the first and second trigger-event conditions both evaluate to true, performing the action.

FIG. 4B shows a third example scenario in which a user utilizes the type of UI view described above to build a new rule comprising a trigger event having two trigger-event conditions and an action, where the action is to be carried out in response to either one of the trigger-event conditions evaluating to true (i.e., the two trigger-event conditions are logically connected by an “OR” operator).

As shown, in this third example scenario, the “rule creation” workspace had been updated to include a first “condition” UI element that represents a first trigger-event condition, a second “condition” UI element that represents a second trigger-event condition, and an “action” UI element that represents an action, each of which may be created in a similar manner to the instances of “condition” and “action” UI elements described above. In particular, each such UI instance may be added to the “rule creation” workspace and configured via a “condition” or “action” dialog so as to represent a trigger-event condition or action defined by the user.

Further, as shown, the first “condition” UI element and the second “condition” UI element are each interconnected with the “action” UI element via a respective interconnection line, which represents that if either the first trigger-event condition or the second trigger-event condition evaluates to true, the action is to be carried out. In this respect, execution of the new rule represented by the arrangement of UI elements shown in FIG. 4B may involve (i) determining whether either one of the first or second trigger-event conditions evaluate to true, and (ii) in response to a determination that either one of the first or second trigger-event conditions evaluate to true, performing the action.

FIG. 4C shows a fourth example scenario in which a user utilizes the type of UI view described above to build a new rule comprising a trigger event having a single trigger-event condition and two actions, where both actions are to be carried out in response to the trigger-event condition evaluating to true.

As shown, in this fourth example scenario, the “rule creation” workspace had been updated to include a “condition” UI element that represents an trigger-event condition, a first “action” UI element that represents a first action, and a second “action” UI element that represents a second action, each of which may be created in a similar manner to the instances of “condition” and “action” UI elements described above. In particular, each such UI instance may be added to the “rule creation” workspace and configured via a “condition” or “action” dialog so as to represent a trigger-event condition or action defined by the user.

Further, as shown, the “condition” UI element is interconnected with both the first “action” UI element and the second “action” UI element via respective interconnection lines, which represents that when the trigger-event condition evaluates to true, both the first and second actions are to be carried out. In this respect, execution of the new rule represented by the arrangement of UI elements shown in FIG. 4C may involve (i) determining whether the trigger-event condition evaluates to true, and (ii) in response to a determination that the trigger-event condition evaluates to true, performing both the first and second actions.

FIG. 4D shows a fifth example scenario in which a user utilizes the type of UI view described above to build a new rule comprising a trigger event having three trigger-event conditions and two actions, where (i) the first action is to be carried out in response to the first and second trigger-event conditions both evaluating to true (i.e., the first and second trigger-event conditions are logically connected by an “AND” operator) and (ii) the second action is to be carried out in response to either the first and second trigger-event conditions both evaluating to true or the third trigger-event condition evaluating to true (i.e., the third trigger-event condition logically connected by “OR” operator with the first and second trigger-event conditions).

As shown, in this fifth example scenario, the “rule creation” workspace had been updated to include a first “condition” UI element that represents a first trigger-event condition, a second “condition” UI element that represents a second trigger-event condition, a third “condition” UI element that represents a third trigger-event condition, a first “action” UI element that represents a first action, and a second “action” UI element that represents a second action, each of which may be created in a similar manner to the instances of “condition” and “action” UI elements described above. In particular, each such UI instance may be added to the “rule creation” workspace and configured via a “condition” or “action” dialog so as to represent a trigger-event condition or action defined by the user.

Further, as shown, the first “condition” UI element is interconnected with the second “condition” UI element via a respective interconnection line, the second “condition” UI element is interconnected with both the first “action” UI element and the second “action” UI element via respective interconnection lines, and the third “condition” UI element is also interconnected with the second “action” UI element via a respective interconnection line, which represents that (i) if the first and second trigger-event conditions both evaluate to true, then both the first and second actions are to be carried out and (ii) if the third trigger-event condition evaluates to true, then the second action (but not the first action) is to be carried out. In this respect, execution of the new rule represented by the arrangement of UI elements shown in FIG. 4A may involve (i) determining whether either the first and second trigger-event conditions both evaluate to true or the third trigger-event evaluates to true, and then either (ii) performing both the first and second actions in response to a determination that the first and second trigger-event conditions both evaluate to true, or (iii) performing the second action (but not the first action) in response to a determination that the first and second trigger-event conditions do not both evaluate to true but that the third trigger-event condition evaluates to true.

The example scenarios shown in FIGS. 3A-3L and 4A-4D are only some possible scenarios, and in practice a user may utilize the type of UI view described above to build rules comprising various other combinations of trigger-event conditions and/or actions.

After the user has finished providing the user input specifying the set of one or more trigger-event conditions and the set of one or more actions for the new rule via the example user interface running on the software-provider client device 116A, the user may then input an indication that the new rule is completed and ready to be deployed. For instance, the example user interface may include a selectable icon (e.g., a “Deploy” button) that the user can click when finished with the process of creating the new rule in order to indicate to the software-provider client device 116A that the rule is completed and ready to be deployed, among other possible ways that the user may input an indication that the new rule is completed and ready to be deployed.

Returning to FIG. 2 and block 256, after receiving the user input for creating the new rule related to the observability behavior of the given client application, the software-provider client device 116A may transmit a request to the client configuration service 112 to deploy the new rule for execution by at least some instances of the given client application. In practice, this request may take the form of one or more request messages (e.g., one or more HTTP messages) that are sent over the respective communication path between the software-provider client device 116A and the back-end platform 104, and in at least some implementations, the one or more request messages may be sent via an API. However, the software-provider client device's request to deploy the new rule for execution may take other forms as well.

Further, the request to deploy the new rule for execution may include any of various information related to the new rule. For instance, in line with the discussion above, the request to deploy the new rule for execution may include information specifying the trigger event and the set of one or more actions for the new rule, identifying information for the new rule (e.g., name, category, brief description, etc.), and perhaps also information indicating which particular instances of the given client application are to be configured to execute the new rule, which could take any of the various forms described above. The request to deploy the new rule for execution may include other types of information and/or take other forms as well.

At block 260, the client configuration service 112 of the back-end platform 104 may then receive the request to deploy the new rule for execution by at least some instances of the given client application that was sent by the software-provider client device 116A. In turn, the client configuration service 112 may carry out various operations in order to deploy the new rule for execution by at least some instances of the given client application.

For instance, at block 262, the client configuration service 112 may identify which one or more instances of the given client application are to be configured to execute the new rule. This function of identifying which one or more instances of the given client application are to be configured to execute the new rule may take various forms.

In some implementations, the client configuration service 112 may be configured to deploy each new rule for execution by some predefined universe of currently-installed instances of the given client application—such as all currently-installed instances of the given client application—in which case the client configuration service 112 may function to identify that predefined universe of currently-installed instances of the given client application as the instances of the given client application that are to be configured to execute the new rule.

In other implementations, the client configuration service 112 may be configured to identify which one or more instances of the given client application are to be configured to execute the new rule based on information included in the request to deploy the new rule for execution that is received from the software-provider client device 116A. This function may take various forms, which may depend in part on the nature of the information included in the request to deploy the new rule for execution.

For instance, in a scenario where the request to deploy the new rule for execution includes identifying information for one or more specific instances of the given client application that are to be configured to execute the new rule, the client configuration service 112 may identify at least the one or more specific instances of the given client application as instances of the given client application that are to be configured to execute the new rule. Further, in such a scenario, the client configuration service 112 could also optionally be configured to identify additional instances of the given application that are to be configured to execute the new rule, such as additional instances of the given client application that share some common characteristic with the one or more specific instances of the given client application identified in the request to deploy the new rule for execution (e.g., being installed on similar types of end-user client devices and/or being installed on end-user client device that are located in a similar geographic area, etc.).

Alternatively, in a scenario where the request includes criteria for identifying instances of the given client application, the client configuration service 112 may identify the instances of the given client application that are to be configured to execute the new rule by evaluating which currently-installed instances of the given client application satisfy the criteria.

For example, if the request includes criteria for identifying instances of the given client application that are installed on the end-user client devices located within a specified geographic area, the client configuration service 112 may evaluate the geographic locations of end-user client devices that are currently installed with the given client application in order to determine which of those end-user client devices have a geographic location within specified geographic area and may then identify the instances of the given client application installed on those end-user client devices as the instances of the given client application that are to be configured to execute the new rule.

As another example, if the request includes criteria for identifying instances of the given client application that are of a specified version, the client configuration service 112 may evaluate the versions of the currently-installed instances of the given client application in order to determine which of the currently-installed instances of the given client application have the specified version and may then identify those currently-installed instances as the instances of the given client application that are to be configured to execute the new rule.

As yet another example, if the new rule incudes one or more client-instance filters (e.g., for trigger-event conditions and/or actions) that are identified within the request as part of the information specifying the trigger event and the set of one or more actions for the new rule, then the client configuration service 112 may utilize the one or more client-instance filters as criteria for identifying instances of the given client application that are to be configured to execute the new rule. As one example, if the new rule includes a client-instance filter for a trigger-event condition and/or for an action of the new rule, then the client configuration service 112 may determine which of the currently-installed instances of the given client application satisfy the client-instance filter and then then identify those currently-installed instances as the instances of the given client application that are to be configured to execute the new rule. However, in other implementations, the client configuration service 112 may deploy the new rule without reference to any client-instance filter(s) that may be included as part of the new rule, in which case the client-instance filter(s) may be utilized by the installed instances of the given client application to determine whether and to what extent the new rule is to be executed.

Various other examples are possible as well.

Alternatively yet, in a scenario where the request includes an indication that every installed instance of the given client application should be configured to execute the new rule, the client configuration service 112 may identify all currently-installed instances of the given client application as instances of the given client application that are to be configured to execute the new rule.

The function of identifying which one or more instances of the given client application are to be configured to execute the new rule based on information included in the request to deploy the new rule for execution that is received from the software-provider client device 116A may take various other forms as well.

The client configuration service's functionality for identifying which one or more instances of the given client application are to be configured to execute the new rule in other manners as well—including but not limited to the possibility that this functionality could also involve an evaluation of whether the currently-installed instances of the given client application have the capability to execute the new rule (e.g., based on factors such as the permissions assigned to the installed instance of the given client application and/or the data that is available to the installed instance of the given client application).

Further, in order to facilitate this functionality of identifying which one or more instances of the given client application are to be configured to execute the new rule, the client configuration service 112 may have access to information regarding the currently-installed instances of the given client application and/or the end-user client devices on which such instances are installed, among other possible information that may facilitate the functionality of identifying which one or more instances of the given client application are to be configured to execute the new rule.

At block 264, after receiving the request to deploy the new rule for execution, the client configuration service 112 may also generate configuration data for the new rule that is to be transmitted to each end-user client device that installed with an identified instance of the given client application. At a high level, this configuration data for the new rule may comprise data defining the trigger event and the set of one or more actions for the new rule, which may be represented in a structured format that can be used to generate executable logic for a configurable rule engines of the given client application. Additionally, the generated configuration data for the new rule may include or be associated with an identifier of the new rule (e.g., a rule ID generated by the client configuration service 112). The generated configuration data for the new rule may take other forms as well.

Further, in some implementations, it is possible the request to deploy the new rule for execution could include structured configuration data for the new rule, in which case the function of generating the configuration data for the new rule may involve extracting the structured configuration data from the request and then perhaps updating and/or supplementing the structured configuration data.

In a scenario where the new rule includes one or more client-instance filters associated with the trigger event and/or set of one or more actions of the new rule, the function of generating configuration data for the new rule may also account for the one or more client-instance filters. For instance, as one possibility, the client configuration service 112 may include data defining the one or more client-instance filters as part of the configuration data defining the trigger event and the set of one or more actions for the new rule that is generated by the client configuration service 112, in which case the data defining the one or more client-instance filters may then be utilized by the instances of the given client application when configuring the configurable rules engine to execute the new rule (or perhaps during execution of the new rule).

Additionally or alternatively, as another possibility, the client configuration service 112 may utilize the one or more client-instance filters of the new rule as a basis for generating different sets of configuration data for different end-user client devices that are installed with identified instances of the given client application. For example, if a client-instance filter for a given trigger-event condition of the new rule specifies that the given trigger-event condition is to be evaluated by a given group of end-user client devices installed with the given client application (e.g., end-user client device installed with iOS), the client configuration service 112 may utilize this client-instance filter as a basis for generating two sets of configuration data-a first set of configuration data for the given group of end-user client devices that defines the given trigger-event condition to be part of the new rule and a second set of configuration data for the rest of the end-user client devices installed with the given client application that does not define the given trigger-event condition to be part of the new rule. As another example, if a client-instance filter for a given action of the new rule specifies that the given action is to be carried out by a given group of end-user client devices installed with the given client application (e.g., end-user client device installed with iOS), the client configuration service 112 may utilize this client-instance filter as a basis for generating two sets of configuration data-a first set of configuration data for the given group of end-user client devices that defines the given action to be part of the new rule and a second set of configuration data for the rest of the end-user client devices installed with the given client application that does not define the given action to be part of the new rule. Depending on the number, type, and/or interrelationship of the client-instance filters that are included as part of the rule, the client configuration service 112 may also generate more than two sets of configuration data for more than two different groups of end-user client devices.

Thereafter, at block 266, the client configuration service 112 may cause the configurable rules engine of each identified instance of the given client application to become configured to execute the new rule. To accomplish this, the client configuration service 112 may transmit the configuration data for the new rule to each end-user client device that is installed with an identified instance of the given client application. For instance, as shown in FIG. 2B, the client configuration service 112 may transmit the configuration data for the new rule to the end-user client device 102A, which may be one of the end-user client devices installed with an identified instance of the given client application. In this respect, the configuration data for the new rule may be packaged into one or more messages (e.g., one or more HTTP messages) that are sent over the respective communication path between the back-end platform 104 and the end-user client device 102A, and in at least some implementations, the one or more request messages may be sent via an API. Along similar lines, the client configuration service 112 may also transmit the configuration data for the new rule to either or both of the end-user client devices 102B-C. In line with the previous discussion, it is also possible that different sets of configuration data may be transmitted to different end-user client devices.

Although not shown in FIG. 2B, the client configuration service 112 may also write certain information about the deployed rule to the rules data store 114. The information about the deployed rule that is written to the rules data store 114 may take various forms, examples of which may include information about the new rule that was included in the request to deploy the new rule for execution and/or the generated configuration data for the new rule, among other possibilities.

At block 270, the given client application installed on end-user client device 102A may receive the configuration data for the new rule that is sent by the back-end platform 104. In turn, at block 272, the given client application installed on the end-user client device 102A may, based on the configuration data for the new rule, configure its configurable rules engine to execute the new rule during runtime sessions of the given client application. For instance, the given client application may utilize the configuration data for the new rule to generate executable logic (e.g., program code) for the configurable rules engine and then configure the configurable rules engine to execute the executable logic during runtime sessions of the given client application, among other possible ways that the given client application may configure its configurable rules engine to execute the new rule based on the configuration data.

In a scenario where the configuration data for the new rule defines one or more client-instance filters associated with the trigger event and/or set of one or more actions of the new rule, then as part of configuring the configurable rules engine to execute the new rule, the given client application may also evaluate whether the one or more client-instance filters are met and then adapt the new rule accordingly. For example, if the given client application determines that a client-instance filter for a given trigger-event condition of the new rule is not met (e.g., because instance of the given client application and/or the end-user client device does not meet some criterion defined as part of the filter), then as part of configuring the configurable rules engine to execute the new rule, the given client application may remove the given trigger-event condition from the new rule. As another example, if the given client application determines that a client-instance filter for a given action of the new rule is not met (e.g., because instance of the given client application and/or the end-user client device does not meet some criterion defined as part of the filter), then as part of configuring the configurable rules engine to execute the new rule, the given client application may remove the given action from the new rule. Other examples are possible as well.

At block 274, after the given client application's configurable rules engine has been configured to execute the new rule during runtime sessions of the given client application, the end-user client device 102A may initiate a given runtime session of the given client application.

At block 276, in response to the given runtime session of the given client application being initiated, the given client application may begin capturing log information and/or associated contextual information for the given runtime session that is to be reported in accordance with the default observability behavior of the given client application, among other possible actions that the given client application may carry out in accordance with its default observability behavior.

At block 278, in response to the given runtime session of the given client application being initiated, the given client application' configurable rules engine may also initiate execution of the new rule as applied to the given runtime session and then continue executing the new rule during the course of the given runtime session. At a high level, the configurable rules engine's execution of the new rule during the given runtime session may involve (i) monitoring for the new rule's trigger event during the given runtime session, and (ii) if an occurrence of the trigger event is detected during the given runtime session, causing the new rule's set of one or more actions to be carried out such that there is some change in the observability behavior of the given client application. In this respect, the new rule's trigger event and set of one or more actions may take any of various forms, including but not limited to any of the various forms described above. Further, if the new rule's set of one or more actions involves the reporting of additional log and/or contextual information for the entirety of a runtime session if the trigger event is detected (or some other window of time that begins prior to the trigger event), then the configurable rules engine's execution of the new rule during the given runtime session may additionally involve causing the given client application to provisionally capture the additional log and/or contextual information prior to the detection of the trigger event so as to enable such information to be reported for the portion of the given runtime session that precedes the detection of the trigger event. The configurable rules engine's execution of the new rule during the given runtime session may involve other operations as well.

At block 280, while the given client application is capturing log information and/or associated contextual information in accordance with the default observability behavior and the given client application's configurable rules engine is executing the new rule during the given runtime session, the configurable rules engine may optionally (i) detect an occurrence of the new rule's trigger event and (ii) based on detecting the occurrence of the new rule's trigger event, trigger the given client application to carry out new rule's set of one or more actions. In line with the discussion above, this may involve triggering the given client application to capture and/or report a different scope of log information and/or contextual information for the given runtime session, triggering the given client application to initiate a live support session and/or interactive debugging session, triggering the given client application to prompt the end user to provide a certain type of user input, and/or triggering the given client application to engage in some other interaction with the back-end platform 104 and/or the end user, among other possible types of actions.

At block 282, the given client application then report the log information and/or associated contextual information for the given runtime session to the back-end platform 104, which may involve causing the end-user client device 102A to transmit the log information and/or associated contextual information for the given runtime session to be transmitted to the back-end platform 104 over the respective communication path between the end-user client device 102A and the back-end platform 104. In line with the discussion above, the timing of this reporting of the log information and/or associated contextual information for the given runtime may vary depending on the implementation of the client application. For instance, in one possible implementation, the given client application may report the log information and/or associated contextual information for the given runtime session to the back-end platform 104 at the time that the given runtime session concludes, regardless of whether or not the end-user client device 102A is connected to a Wi-Fi network at that time. In another implementation, if the end-user client device 102A is only connected to a cellular network and not a Wi-Fi network when the given runtime session concludes, the given client application may report the log information and/or associated contextual information for the given respective runtime session of the given client application to the back-end platform 104 at the time that the end-user client device 102A re-connects to a Wi-Fi network. The end-user client device 102A may report the log information and/or associated contextual information for the given runtime session to the back-end platform 104 at other times as well.

Further, the scope of the log information and/or associated contextual information that is reported to the back-end platform 104 at block 282 may depend on whether the new rule's trigger event was detected during the given runtime session. For instance, if the configurable rules engine did not detect the new rule's trigger event during the given runtime session, the given client application may report the default scope of log information and/or associated contextual information for the given runtime session in accordance with the default observability behavior. On the other hand, if the configurable rules engine did detect the new rule's trigger event during the given runtime session, then the given client application may report both (i) the default scope of log information and/or associated contextual information for the given runtime session and also (ii) certain additional log information and/or associated contextual information for the given runtime session in accordance with the new rule.

The back-end platform 104 may then receive and handle the log information and/or associated contextual information for the given runtime session in a similar manner to that described above in FIG. 2A.

The given client application may then continue to operate in a similar manner for each subsequent runtime session of the given client application while the configurable rules engine remains configured to execute the new rule.

Further, while the foregoing discussion is directed to creating, deploying, and configuring a configurable rules engine of the given client application to execute one new rule, it should be understood that the foregoing functionality may be carried out in order to create, deploy, and configure a configurable rules engine of the given client application to execute multiple different rules. For example, utilizing the disclosed technology, the configurable rules engine of the given client application installed on the end-user client device 102A could be configured to execute multiple different rules during runtime sessions of the given client application, in which case the configurable rules engine may monitor for multiple different types of trigger events during each runtime session of the given client application.

Further yet, after a new rule is created and deployed in the manner described above, the disclosed technology may also enable a user associated with the given software provider to update or delete a previously-deployed rule. For example, the client configuration tool's user interface may additionally enable users to edit, delete, activate, and/or deactivate a rule that has previously been deployed for execution by one or more instances of the given client application. In this respect, if a user updates or deletes a previously-deployed rule, the client configuration service 112 may then communicate with the end-user client device(s) installed with the identified instance(s) of the given client application so as to cause the configurable rules engine(s) to update or delete the previously-deployed rule.

Still further, at least some implementations, the client configuration tool's user interface could also enable users to view execution data for a rule that has previously been deployed for execution by one or more instances of the given client application (e.g., a listing of runtime sessions during which the rule was satisfied).

The functionality of creating, deploying, and configuring the given client application's configurable rules engine to execute a new rule in accordance with the disclosed technology may take various other forms as well.

Further, while the disclosed technology has been described above in the context of creating, deploying, and configuring the given client application's configurable rules engine to execute a new rule related to the given client application's observability behavior, the disclosed technology may likewise be utilized to create, deploy, and configure the given client application's configurable rules engine to execute a new rule related to some other aspect of the given client application's operation.

Further yet, in addition or in alternative to configuring the given application to execute a new rule by sending configuration data for a new rule to a configurable rules engine embedded within the given client application, the disclosed technology may involve configuring the given client application to perform additional or modified functionality that is embodied in the form of executable code received from the back-end platform 104, where such executable code, when executed by the client device running the given client application, causes the end-user client device 102A to perform the additional or modified functionality while running the given client application. To facilitate this functionality, the client configuration tool described above may enable a user acting on behalf of the software provider to create or otherwise input executable code for causing a client application to perform additional or modified functionality, and the client application may be embedded with a configurable code engine (or the like) that is operable to load and execute code for performing the additional or modified functionality that is received from a back-end platform. In this respect, a client application could be embedded with one or both of a configurable rules engine and a configurable code engine, and in an implementation where the client application is embedded with both a configurable rules engine and a configurable code engine, it is also possible that such engines could either be standalone engines or be integrated together into a single configurable engine. Further, the additional or modified functionality of a client application that is embodied in the form of executable code could take any of various forms, and in at least some implementations, may include functionality for applying rules related to the observability behavior of the client application that are similar to those described herein in the context of the configurable rules engine (e.g., rules comprising a trigger event and one or more actions). However, such functionality could take other forms as well.

For instance, a user utilizing the client configuration tool may create or input executable code that embodies the functionality for applying a new rule related to the observability behavior of the given client application, and the client configuration service 112 may transmit the executable code to one or more client devices running the given client application. In turn, the one or more client devices may each function to execute the received executable code for applying the new rule while running the given client application.

While the foregoing functionality is described in the context of rules related to the observability of the given client application, as noted above, a client application's configurable rules engine could additionally or alternatively be configured to execute one or more rules related to some other aspect of the client application's operation as well (i.e., some aspect of the client application's operation that does not relate to its observability behavior), where each such rule comprises (i) a respective type of trigger event that is to trigger a change in the operation of the client application if detected, and (ii) a respective set of one or more actions related to the operation of the client application that is to be carried out if the respective type of trigger event is detected by the configurable rules engine. In this respect, once a client application's configurable rules engine is configured to execute such a rule, then during runtime sessions of the client application, the configurable rules engine may likewise function to (i) monitor for the given rule's trigger event, and (ii) if an occurrence of the given rule's trigger event is detected, cause the one or more actions related to the operation of the client application to be carried out.

Moreover, while the foregoing functionality is described in the context of a given client application that has been installed on end-user client devices, as noted above, one of ordinary skill in the art will understand and appreciate that client applications running on end-user client devices are one example type of software applications that run on computing systems, and that the disclosed software technology may likewise be utilized with other types of software applications running on other types of computing systems (e.g., servers, other types of endpoint devices, etc.), so as to enable other types of software applications running on other types of computing systems to change their operation dynamically during runtime (e.g., based on the state and/or operation of the software application, the state and/or operation of the computing device running the software application, etc.) rather than requiring that a new version of such software applications be released to implement the changes to the operation of the software applications. In particular, as with the given client application described above with reference to FIGS. 2A-2B, 3A-3L, and 4A-4D, another type of software application may be embedded with a configurable rules engine that can be configured to execute one or more rules related to the operation of the software application (e.g., the observability behavior of the software application), where each such rule comprises (i) a respective type of trigger event and (ii) a respective set of one or more actions related to the operation of the software application that is to be carried out if the respective type of trigger event is detected by the configurable rules engine. Additionally or alternatively, as with the given client application described above, another type of software application may be embedded with a configurable code engine that is operable to load and execute code for causing the software application to perform additional or modified functionality that is received from a back-end platform.

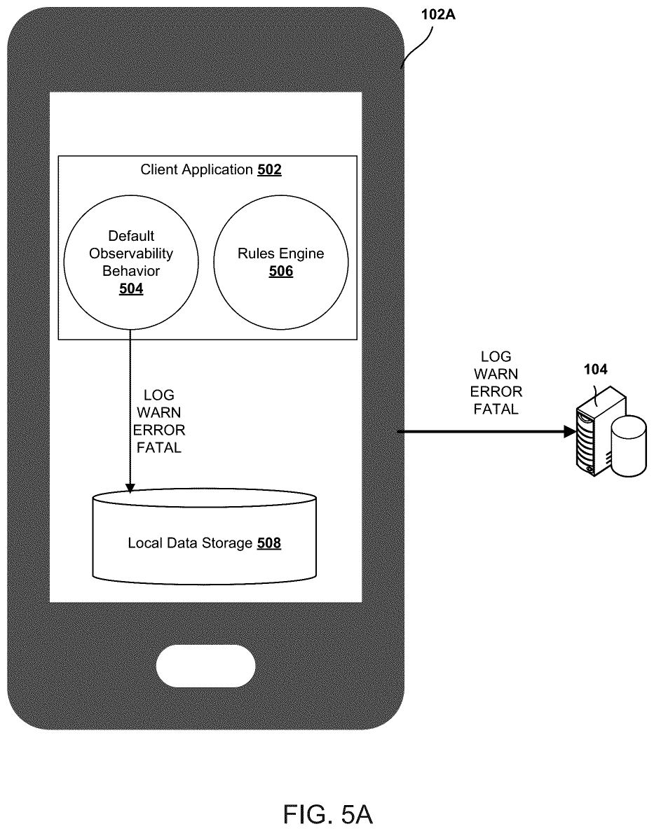

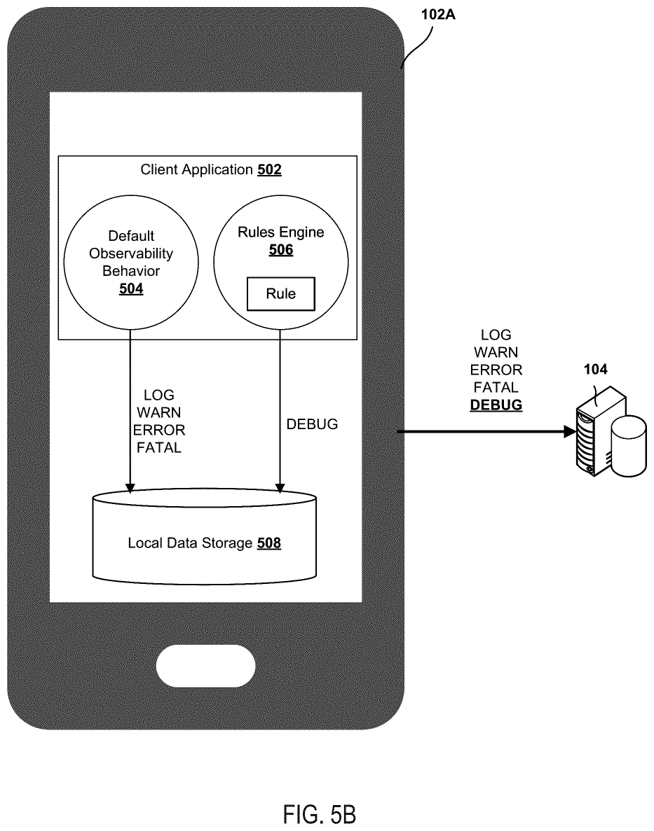

For purposes of illustration, one example use case of the disclosed technology will now be described with reference to FIGS. 5A-5B, which show a scenario involving the example end-user client device 102A and the example back-end platform 104 of FIGS. 1 and 2A-2B. In this scenario, the end-user client device 102A has been installed with an example client application 502 comprising default observability behavior 504 and a rules engine 506 (i.e., a configurable rules engine).

FIG. 5A illustrates the logging functionality of the example client application 502 during a first period of time while the client application 502 is configured to operate in accordance with the client application's default observability behavior 504 and is not executing any rules related to the client application's observability behavior. As shown, this logging functionality may involve capturing and reporting log information utilizing a log level of INFO, which means that log entries having log levels of INFO, WARN, ERROR, and FATAL will be captured and reported for runtime sessions of the client application 502 in accordance with the default observability behavior 504 of the client application 502. In this respect, during each runtime session, the client application 502 may function to capture log entries having log levels of INFO, WARN, ERROR, and FATAL, write the captured log entries having log levels of INFO, WARN, ERROR, and FATAL to local data storage 508 of the end-user client device 102A, and report the log entries having log levels of INFO, WARN, ERROR, and FATAL to the back-end platform 104 (e.g., at the conclusion of the runtime session or at some other time).

In turn, FIG. 5B illustrates the logging functionality of the example client application 502 during a second period of time while the configurable rules engine of the client application 502 is configured to execute an example rule specifying that if a specified trigger event is detected during a given runtime session of the client application 502, then the client application 502 is to additionally report log entries having a DEBUG level for the entire runtime session to the back-end platform 104. In this respect, during each runtime session, the client application 502 may continue to capture log entries having log levels of INFO, WARN, ERROR, and FATAL, write the captured log entries having log levels of INFO, WARN, ERROR, and FATAL to the local data storage 508 of the end-user client device 102A, and report the log entries having log levels of INFO, WARN, ERROR, and FATAL to the back-end platform 104. However, in addition to this logging functionality that is carried out during each runtime session in accordance with the default observability behavior 504, the client application 502 that is configured, via the rules engine 506, with the example rule may also function to provisionally capture log entries having a log level of DEBUG, write the provisionally-captured log entries having the log level of DEBUG to local data storage 508 of the end-user client device 102A, and then if the specified trigger event is detected, additionally report the log entries having the log level of DEBUG to the back-end platform 104 (e.g., at the conclusion of the runtime session or at some other time).

The rules that can be executed by the rules engine 506 of the client application 502 may take various other forms as well.

In line with the discussion above, the logging functionality disclosed herein may involve a client application writing various types of log information and/or associated contextual information to a client device's local data storage during a runtime session of the client application. For instance, as a starting point, the client application may be configured to write a “default” set of log information and/or associated contextual information that is captured in accordance with the client application's default observability behavior (i.e., a set of log information and/or associated contextual information that is captured and reported regardless of whether any trigger event is detected) to a client device's local data storage during a runtime session of the client application. Further, if the client application's configurable rules engine has been configured to execute one or more rules related to observability behavior, the client application may be configured to write certain additional information to the client device's local data storage during a runtime session of the client application in connection with the one or more rules.

In this respect, for certain types of rules, the client application could be configured to write additional information to the client device's local data storage even prior to detecting the rule's trigger event. For example, if the configurable rules engine of the client application is configured to execute a rule specifying that one or more additional levels of log information are to be reported for a runtime session if a given trigger event is detected during the runtime session, then the client application could be configured to write the one or more additional levels of log information to the client device's local data storage throughout the entire runtime session so that the client application is capable of reporting the additional one or more levels of log information for the entire runtime session if the trigger event is detected at some point during the runtime session. As another example, if the configurable rules engine of the client application is configured to execute a rule specifying that certain contextual information preceding a given trigger event is be reported for a runtime session if the given trigger event is detected during the runtime session, then the client application could be configured to write that contextual information to the client device's local data storage throughout the entire runtime session so that the client application is capable of reporting the contextual information preceding the trigger event if the trigger event is detected at some point during the runtime session (e.g., contextual information for some window of time leading up to the trigger event). Many other examples are possible as well.

Additionally or alternatively, for other types of rules, the client application could be configured to write additional information to the client device's local data storage after detecting a rule's trigger event. For example, if the configurable rules engine of the client application is configured to execute a rule specifying that certain contextual information is to be captured at the time that a given trigger event is detected during a runtime session (and thereafter reported), such as a representation of the client application's user interface, a snapshot of the client application's thread stack and/or memory usage, or a snapshot of certain state information for the client device, then the client application may write such contextual information to the client device's local storage at the time that it detects an occurrence of the given trigger event. As another example, if the configurable rules engine of the client application is configured to execute a rule specifying that certain additional log information and/or contextual information is to be captured for the remainder of a runtime session if a given trigger event is detected (and thereafter reported), then the client application may write such additional log information and/or contextual information to the client device's local storage from the time that it detects an occurrence of the given trigger event until the end of the runtime session. Many other examples are possible as well.

In accordance with the present disclosure, any of various storage architectures may be utilized to store log information and/or associated contextual information for a runtime session of the client application within a client device's local storage.

According to one possible implementation, a client application may be configured to (i) write log information and/or associated contextual information that is captured in accordance with the client application's default observability behavior to a first set of one or more storage structures within a client device's local storage and (ii) write any additional information that is captured in accordance with one or more rules being executed by the client application's configurable rules engine to a second set of one or more storage structures within the client device's local storage. In this implementation, the client application may then be configured such that, when reporting log information and/or associated contextual information for a runtime session to the back-end platform 104, the client application (i) may always read from the first set of one or more storage structures within the client device's local storage and (ii) may additionally read from the second set of one or more storage structures within the client device's local storage if a rule specifying the reporting of additional information was satisfied during the runtime session.

To illustrate with an example, consider a scenario where a client application is programmed with a default logging level of INFO and has also been configured with a rule specifying that a DEBUG-level of log information is to be reported for a runtime session if a given trigger event is detected, as described in FIG. 5B. According to this implementation, the client application may be configured to (i) write INFO-, WARN-, ERROR-, and FATAL-levels of log information for a runtime session to a first storage structure within the client device's local storage that is to be read by default when reporting log information for the runtime session and (ii) write DEBUG-level of log information for a runtime session to a second storage structure within the client device's local storage that is only to be read when reporting log information for the runtime session if the given trigger event was detected during the runtime session.

According to another possible implementation, a client application may be configured to write log information and/or associated contextual information that is captured in accordance with the client application's default observability behavior as well as any additional information that is captured in accordance with one or more rules being executed by the client application's configurable rules engine to a common set of one or more storage structures that stores such information together. In this implementation, the client application may then be configured such that, when reporting log information and/or associated contextual information to the back-end platform 104, the client application may (i) read from the common set of one or more storage structures within the client device's local storage and then (ii) selectively determine which of the information in the common set of one or more storage structures to report for the runtime session based on which rules (if any) were satisfied during the runtime session.

To illustrate with an example, again consider a scenario where a client application is programmed with a default logging level of INFO and has also been configured with a rule specifying that a DEBUG-level of log information is to be reported for a runtime session if a given trigger event is detected. According to this implementation, the client application may be configured to write DEBUG-, INFO-, WARN-, ERROR-, and FATAL-levels of log information for a runtime session to a common storage structure within the client device's local storage, and then when reporting log information for the runtime session, the client application may (i) select the INFO-, WARN-, ERROR-, and FATAL-levels of log information for reporting by default and (ii) determine whether or not to additionally select the DEBUG-level of log information for reporting depending on whether or not the rule was satisfied during the runtime session.

The storage architecture that is utilized to store log information and/or associated contextual information for a runtime session of the client application within a client device's local storage may take other forms as well, including but not limited to the possibility that the client application could utilize an additional set of one or more storage structures to store log information and/or contextual information that has been reported to back-end platform 104. In such an implementation, the client application may be configured to transfer the reported log information and/or contextual information from the set of one or more storage structures where it was originally written to this additional set of one or more storage structures after the log information and/or contextual information has been transmitted to the back-end platform 104, where it may then be stored for some additional period of time so as to make the log information and/or contextual information available for re-transmission to the back-end platform 104 if necessary (e.g., due to a network failure or the like).

Further, the storage architecture that is utilized to store log information and/or associated contextual information for a runtime session of the client application within a client device's local storage may include storage structures having any of various forms. For instance, as one possibility, the storage architecture may include one or more volatile storage structures that are allocated within the random access memory (RAM) of the client device, such as one or more RAM-based buffers and/or RAM-based linked lists, among other possible types of volatile storage structures. As another possibility, the storage architecture may include one or more non-volatile storage structures that are allocated within the disk storage of the client device (e.g., the client device's flash disk), such as one or more disk-based buffers, disk-based databases, disk-based file stores, and/or disk-based object stores, among other possible types of non-volatile storage structures. As yet possibility, the storage architecture may include one or more hybrid storage structures that each comprise a combination of volatile and non-volatile storage structures, such as a hybrid buffer structure comprising a RAM-based buffer that is combined together with a disk-based buffer. Other forms of storage structures are possible as well.

In one particular implementation, each storage structure that is utilized to store log information and/or associated contextual information for a runtime session of the client application within a client device's local storage may take the form of a ring buffer, such as a RAM-based ring buffer, a disk-based ring buffer, or a hybrid ring buffer comprising a RAM-based ring buffer that is flushed to a disk-based ring buffer. Such a ring buffer generally comprises a fixed-size allocation of storage space within RAM and/or disk that behaves as though the storage space is continuous and circular in nature (i.e., the end of the ring buffer is connected to the beginning of the ring buffer), so that when the ring buffer is full, writing new data to the ring buffer causes the oldest data in the ring buffer to be overwritten. Additionally, in order to facilitate the logging functionality disclosed herein, such a ring buffer will preferable have certain other characteristics as well.

For instance, as one such characteristic, a ring buffer that is utilized to store log information and/or associated contextual information for a runtime session of the client application may preserve the time sequence of the stored data records such that the data records are stored in the same order that they were captured. As another such characteristic, a ring buffer that is utilized to store log information and/or associated contextual information for a runtime session of the client application may support multiple producers, so that multiple different application threads can concurrently write data records to the ring buffer. As yet another such characteristic, a ring buffer that is utilized to store log information and/or associated contextual information for a runtime session of the client application may support storage of variable-sized data records, which accounts for the fact that the data records containing the log information and/or associated contextual information may vary in size from one data record to another.

To achieve these characteristics, four indexes may be utilized to manage the write/read functionality of the ring buffer: (1) a “next_write_start” index that indicates where the next write will start (empty or overwrite), (2) a “committed_write_start” index that indicates the last committed write, which may trail the “next_write_start” index by multiple records due to out of order commits, (3) a “last_write_end_before_wrap” index that indicates the end of the last write prior to wrapping, which is used to compute the available space at the end of the ring buffer, and (4) a “next_read_start” index that indicates the next record available for reading, which may either trail or be equal to the “committed_write_start” index and may be pushed forward if the “next_write_start” index is advanced beyond the “next read start” index (e.g., during an overwrite).

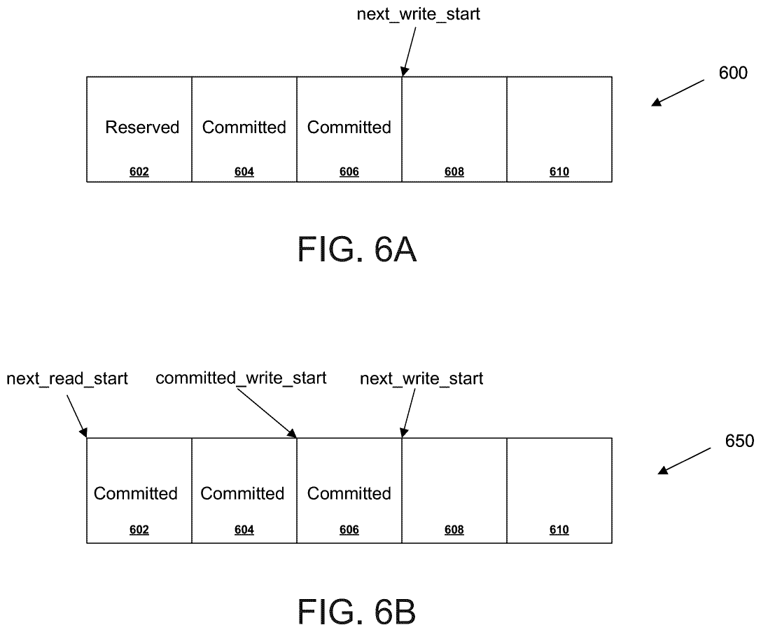

Some illustrations of how these four indexes may be utilized to manage the write/read functionality of a ring buffer are shown in FIGS. 6-8. Beginning with FIG. 6A, an example ring buffer 600 includes a number of storage addresses for storing log information or contextual information for a runtime session of the client application, such as storage addresses 602, 604, 606, 608, and 610. To store data to the ring buffer 600, producers first reserve one of the storage addresses to write respective data to, after which the data is committed to the respective storage address. In the example shown in FIG. 6A, the commits to the storage addresses are out of order. As shown, the storage address 602 is reserved, indicating that a producer intends to write data to the storage address 602. At some point in time after the storage address 602 has been reserved, a producer (the same one or another one) may reserve and then commit data to the storage address 604. Additionally, a producer (the same or yet another one) may also reserve and then commit data to the storage address 606. As shown, these activities may result in the “next_write_start” index pointing to the storage address 608, indicating where a following write operation (e.g., reserve and commit) is to occur.

However, because the data to be written to the storage address 602 has not yet been committed, the commits are out-of-order. To preserve the ability to read the data of all storage addresses in an out-of-order commit scenario, the ring buffer 600 may not be readable until the out-of-order commit scenario is resolved. FIG. 6B includes an example 650 of the ring buffer to show how this issue might be resolved. In the example 650, the storage address 602 has now been committed. As such, the commits to the storage address 602, 604, and 606 are all complete, and the data stored therein may be read. As none of the storage addresses have been read from yet, the “next_read_start” index may point to the first storage address, the storage address 602, as the storage address that is to be read from next. The “committed_write_start” index may point to the storage address 606, as the storage address 606 may be the most recent storage address to be written to (e.g., based on the timing of the reservation of the storage address). Further, the “next_write_start” index may point to the storage address 608, indicating that the storage address 608 is the next available storage address to be written to by a producer.

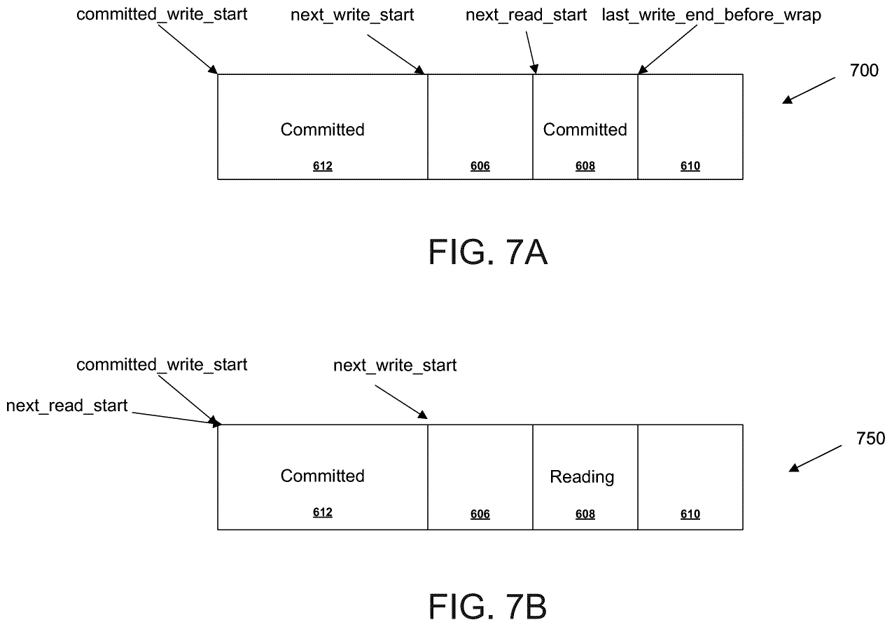

Next, FIGS. 7A-7B show an example of wrapping features of the ring buffer 600. Turning first to FIG. 7A, an example 700 of the ring buffer 600 is shown with data committed to two storage addresses: 612 and 608. In the example 700, the storage address 608 was written to first, and the storage address 602 second, with the storage address 610 being skipped, because it was not large enough to hold the incoming data, which may be of variable size. The indices illustrate this as well, with the “committed_write_start” index pointing to the storage address 612, indicating that the storage address 612 was the last address with data committed to it, the index “next_write_start” pointing to the address 606, indicating that it is the next storage address to be written to, the index “next_read_start” pointing to the storage address 608, indicating the storage address 608 is to be read next (thus illustrating that it was written before the storage address 612, as the “committed_write_start” index trails the “next_read_start” index in the example 700), and the “last_write_end_before_wrap” index pointing to the storage address 610, or rather the position where the storage address 608 ends and the storage address 608 begins, which may be used to calculate that the memory available between the “last_write_end_before_wrap” index and the end of the ring buffer 600 is not enough to store the incoming data.

FIG. 7B shows an example 750 of the ring buffer 600 where the storage address 608 is now being read from in accordance with the indices that were shown in FIG. 7A. Specifically, as the “next_read_start” index was pointing to the storage address 608 in FIG. 7A, the FIG. 7B illustrates the reading operation taking place. When that happens, the “next_read_start” index jumps to the next storage address holding committed data, here the storage address 612.

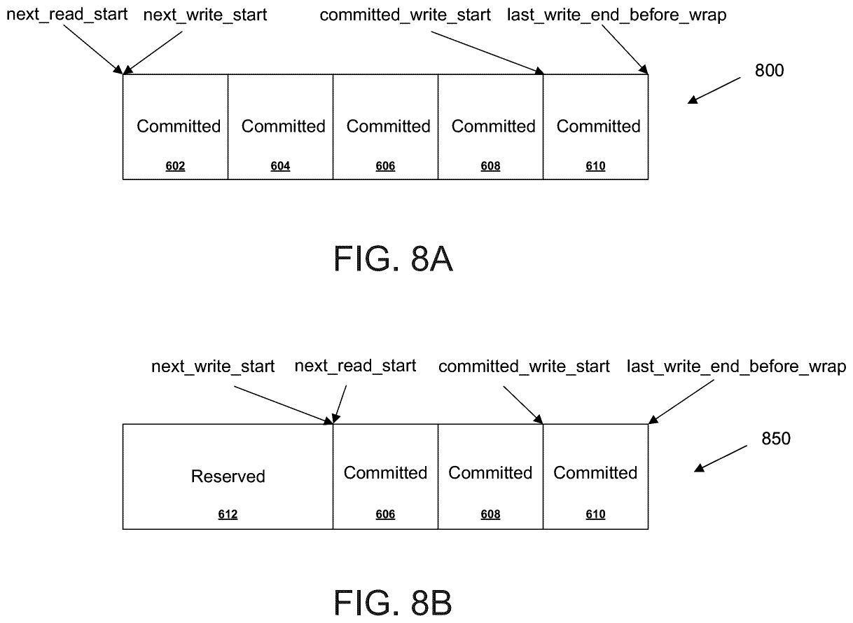

Next, FIGS. 8A-8B show an example of overwriting features of the ring buffer 600. Turning first to FIG. 8A, an example 800 of the ring buffer 600 is shown with data committed to the storage addresses 602, 604, 606, 608, and 610. The indices indicate that the storage address 610 was last committed with data (e.g., as evidenced by the “commited_write_start” index), that there is not enough room after the storage address 610 to store incoming data (e.g., as evidenced by the “last_write_end_before_wrap” index), that the storage address 602 is to be read from next (e.g., as evidenced by the “next_read_start” index), and that the storage address 602 is also to be written to next (e.g., as evidenced by the “next_write_start” index).

Turning now to FIG. 8B, an example 850 of the ring buffer 600 is shown where a write command follows the example 800. In such a case, the data committed to the storage addresses 602 and 604 may be overwritten, and a storage address 612 (which may include the addresses of the storage addresses 602 and 604) may be reserved. The indices illustrate this overwriting operation in more detail. Specifically, the “committed_write_start” index and the “last_write_end_before_wrap” index are unchanged from the example 800, indicating that there has not been another write operation performed. Further, both the “next_write_start” index and the “next_read_start” index have move to point to the storage address 606. As shown, in instances where the “next_read_start” index might otherwise advance in front of the “next_write_start” index, the two advance together. It should be noted that in the example 850, the storage address 606 may be read from even though the storage address 612 is only reserved, and not yet committed to. This is because even though the storage address 612 is positionally “before” the storage address 606, the data committed to the storage address 606 was written “before” data was reserved for the storage address 612. This illustrates how the circular nature of the ring buffer may operate in practice.

The structure and operation of a ring buffer that is utilized to store log information and/or associated contextual information may take various other forms as well.

As noted above, while the disclosed software technology is described herein in the context of client applications that have been installed on client devices, one of ordinary skill in the art will understand and appreciate that client applications running on client devices are one example type of software applications that run on computing devices, and that the disclosed software technology may likewise be utilized with other types of software applications running on other types of computing systems as well.

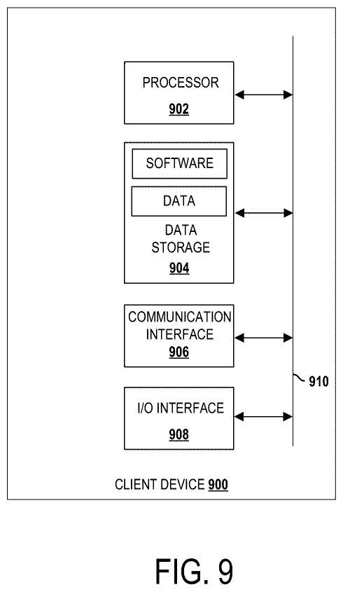

Turning now to FIG. 9, a simplified block diagram is provided to illustrate some structural components that may be included in an example client device 900, which may be configured to carry out any of the various functions disclosed herein. At a high level, client device 900 may include one or more processors 902, data storage 904, one or more communication interfaces 906, and an input/output (I/O) interface 908, all of which may be communicatively linked by a communication link 910 that may that various forms, one example of which is a system bus.

The one or more processors 902 of client device 900 may comprise one or more processor components, each of which may take the form of a general-purpose processor (e.g., a microprocessor), a special-purpose processor (e.g., an application-specific integrated circuit, a digital signal processor, a graphics processing unit, a vision processing unit, etc.), a programmable logic device (e.g., a field-programmable gate array), or a controller (e.g., a microcontroller), among other possibilities.

In turn, data storage 904 of client device 900 may comprise one or more non-transitory computer-readable mediums, each of which may take the form of a volatile medium (e.g., random-access memory, a register, a cache, a buffer, etc.) or a non-volatile medium (e.g., read-only memory, a hard-disk drive, a solid-state drive, flash memory, an optical disk, etc.), and these one or more non-transitory computer-readable mediums may be capable of storing both (i) program instructions that are executable by the one or more processors 902 of the client device 900 such that the client device 900 is configured to perform any of the various client-device functions disclosed herein (e.g., the functionality described above with reference to the end-user client device 102A and/or the software-provider client device 116A), and (ii) data related to the disclosed client-device functionality.

The one or more communication interfaces 908 of client device 900 may take the form of any one or more interfaces that facilitate wireless and/or wired communication with other computing devices or systems, including but not limited to the back-end platform 104 of FIG. 1. Each such communication interface 908 may take any of various forms, examples of which may include an Ethernet interface, a serial bus interface (e.g., Firewire, USB 3.0, etc.), a chipset and antenna adapted to facilitate any of various types of wireless communication (e.g., Wi-Fi communication, cellular communication, short-range wireless protocols, etc.), and/or any other interface that provides for wireless or wired communication. Other configurations are possible as well.

The I/O interface 908 may generally take the form of (i) one or more input interfaces that are configured to receive and/or capture information at the client device 900 and (ii) one or more output interfaces that are configured to output information from client device 900 (e.g., for presentation to a user). In this respect, the one or more input interfaces of I/O interface 908 may include or provide connectivity to input components such as a microphone, a camera, a keyboard, a mouse, a trackpad, a touchscreen, and/or a stylus, among other possibilities. In turn, the one or more output interfaces of I/O interface 908 may include or provide connectivity to output components such as a display screen and/or an audio speaker, among other possibilities.

It should be understood that the client device 900 is one example of a client device that may be used with the example embodiments described herein. Numerous other arrangements are possible and contemplated herein. For instance, in other embodiments, the client device 900 may include additional components not pictured and/or more or fewer of the pictured components.

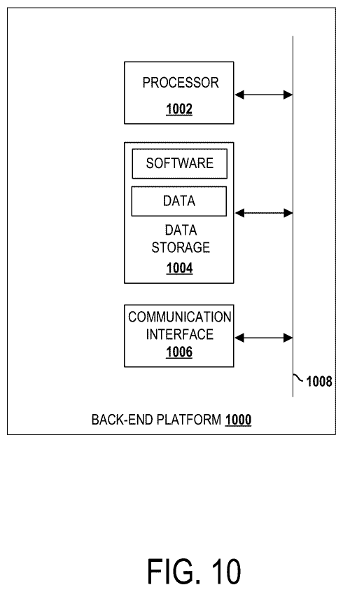

Turning now to FIG. 10, a simplified block diagram is provided to illustrate some structural components that may be included in an example back-end platform 1000, which may be configured to carry out any of the various functions disclosed herein. At a high level, back-end platform 1000 may generally comprise any one or more computing systems that collectively include one or more processors 1002, data storage 1004, and one or more communication interfaces 1006, all of which may be communicatively linked by a communication link 1008 that may take the form of a system bus, a communication network such as a public, private, or hybrid cloud, or some other connection mechanism. Each of these components may take various forms.

The one or more processors 1002 may comprise one or more processor components, each of which may take the form of a general-purpose processor (e.g., a microprocessor), a special-purpose processor (e.g., an application-specific integrated circuit, a digital signal processor, a graphics processing unit, a vision processing unit, etc.), a programmable logic device (e.g., a field-programmable gate array), or a controller (e.g., a microcontroller), among other possibilities. In line with the discussion above, it should also be understood that the one or more processors 1002 could comprise processing components that are distributed across a plurality of physical computing systems connected via a network, such as a computing cluster of a public, private, or hybrid cloud.

In turn, the data storage 1004 may comprise one or more non-transitory computer-readable storage mediums, each of which may take the form of a volatile medium (e.g., random-access memory, a register, a cache, a buffer, etc.) or a non-volatile medium (e.g., read-only memory, a hard-disk drive, a solid-state drive, flash memory, an optical disk, etc.), and these one or more non-transitory computer-readable mediums may be capable of storing both (i) program instructions that are executable by the one or more processors 1002 such that the back-end platform 1000 is configured to perform any of the various back-end platform functions disclosed herein, and (ii) data related to the disclosed back-end platform functionality. In line with the discussion above, it should also be understood that the data storage 1004 may comprise computer-readable storage mediums that are distributed across a plurality of physical computing systems connected via a network, such as a storage cluster of a public, private, or hybrid cloud that operates according to technologies such as AWS for Elastic Compute Cloud, Simple Storage Service, etc.

The one or more communication interface 1006 may take the form of any one or more interfaces that facilitate wireless and/or wired communication with other computing devices or systems, including but not limited to the client devices 102 and 116 of FIG. 1. Each such communication interface 1008 may take any of various forms, examples of which may include an Ethernet interface, a serial bus interface (e.g., Firewire, USB 3.0, etc.), a chipset and antenna adapted to facilitate any of various types of wireless communication (e.g., Wi-Fi communication, cellular communication, short-range wireless protocols, etc.), and/or any other interface that provides for wireless or wired communication. Other configurations are possible as well.

Although not shown, the back-end platform 1000 may additionally include an I/O interface that facilitates user interaction with the back-end platform 1000.

It should be understood that the back-end platform 1000 is one example of a back-end platform that may be used with the embodiments described herein. Numerous other arrangements are possible and contemplated herein. For instance, other back-end platforms may include additional components not pictured and/or more or less of the pictured components.

### CONCLUSION

This disclosure makes reference to the accompanying figures and several example embodiments. One of ordinary skill in the art should understand that such references are for the purpose of explanation only and are therefore not meant to be limiting. Part or all of the disclosed systems, devices, and methods may be rearranged, combined, added to, and/or removed in a variety of manners without departing from the true scope and sprit of the present invention, which will be defined by the claims.

Further, to the extent that examples described herein involve operations performed or initiated by actors, such as “humans,” “curators,” “users” or other entities, this is for purposes of example and explanation only. The claims should not be construed as requiring action by such actors unless explicitly recited in the claim language.

We claim:

1. A computing system, the computing system comprising:
at least one processor;
at least one non-transitory computer-readable medium; and
program instructions stored on the at least one non-transitory computer-readable medium that, when executed by the at least one processor, cause the computing system to:
present a user interface (UI) for creating a rule related to observability behavior of a software application;
receive, via the user interface, a first set of one or more user inputs for creating a first UI element representing a trigger-event condition to be added to the rule related to the observability behavior of the software application;
based on the first set of one or more user inputs, create the first UI element representing the trigger-event condition;
receive, via the user interface, a second set of one or more user inputs for creating a second UI element representing an action to be added to the rule related to the observability behavior of the software application;
based on the second set of one or more user inputs, create the second UI element representing the action; and
send, to a computing platform associated with a software provider of the software application, a request to deploy the rule related to the observability behavior of the software application and thereby cause the computing platform to deploy the rule to a set of one or more computing devices that are installed with the software application, wherein the rule is defined to include the trigger-event condition represented by the first UI element and the action represented by the second UI element.

2. The computing system of claim 1, further comprising program instructions stored on the at least one non-transitory computer-readable medium that, when executed by the at least one processor, cause the computing system to:
receive, via the user interface, a third set of one or more user inputs for creating an interconnection between the first and second UI elements that represents a logical if-then relationship between the trigger-event condition and the action; and
based on the third set of one or more user inputs, create the interconnection between the first and second UI elements that represents the logical if-then relationship between the trigger-event condition and the action, wherein the logical if-then relationship is encoded as part of the rule.

3. The computing system of claim 1, wherein the trigger-event condition represented by the first UI element comprises a first trigger-event condition, and wherein the computing system further comprises program instructions stored on the at least one non-transitory computer-readable medium that, when executed by the at least one processor, cause the computing system to:
receive, via the user interface, a third set of one or more user inputs for creating a third UI element representing a second trigger-event condition to be added to the rule related to the observability behavior of the software application; and
based on the third set of one or more user inputs, create the third UI element representing the trigger-event condition, wherein the rule is defined to include the second trigger-event condition represented by the third UI element.

4. The computing system of claim 3, further comprising program instructions stored on the at least one non-transitory computer-readable medium that, when executed by the at least one processor, cause the computing system to:
receive, via the user interface, a fourth set of one or more user inputs for creating a first interconnection between the first and third UI elements that represents a logical AND relationship between the first trigger-event condition and the second trigger-event condition;
based on the fourth set of one or more user inputs, create the first interconnection between the first and third UI elements that represents the logical AND relationship between the first trigger-event condition and the second trigger-event condition;
receive, via the user interface, a fifth set of one or more user inputs for creating a second interconnection between a given one of the first or third UI elements and the second UI element that represents a logical if-then relationship between the trigger-event conditions and the action; and
based on the fifth set of one or more user inputs, create the second interconnection between the first and third UI elements that represents the logical if-then relationship between the trigger-event conditions and the action,
wherein the logical AND relationship and the logical if-then are encoded as part of the rule.

5. The computing system of claim 1, wherein the first set of one or more user inputs for creating the first UI element representing the trigger-event condition includes one or more user inputs that define a client-instance filter for the trigger-event condition, and wherein the first UI element as created further represents the client-instance filter for the trigger-event condition.

6. The computing system of claim 1, wherein the second set of one or more user inputs for creating the second UI element representing the action includes one or more user inputs that define a client-instance filter for the action, and wherein the second UI element as created further represents the client-instance filter for the action.

7. The computing system of claim 1, wherein the user interface for creating the rule comprises a dialog for creating a UI element representing a condition, wherein the dialog includes one or both of (i) a dropdown list of predefined conditions that are selectable by a user or (ii) a set of one or more input fields for defining the condition in terms of a logical expression, and wherein the first set of one or more user inputs includes at least one user input received via the dialog.

8. The computing system of claim 1, wherein the user interface for creating the rule comprises a dialog for creating a UI element representing an action, wherein the dialog includes one or both of (i) a dropdown list of predefined actions that are selectable by a user or (ii) a set of one or more input fields for defining the action in terms of a logical expression, and wherein the second set of one or more user inputs includes at least one user input received via the dialog.

9. The computing system of claim 1, wherein the user interface for creating the rule comprises an icon for creating an interconnection between the first UI element and the second UI element, wherein the icon is associated with at least one of the first or second UI elements.

10. A non-transitory computer-readable medium, wherein the non-transitory computer-readable medium is provisioned with program instructions that, when executed by at least one processor, cause a computing system to:
present a user interface (UI) for creating a rule related to observability behavior of a software application;
receive, via the user interface, a first set of one or more user inputs for creating a first UI element representing a trigger-event condition to be added to the rule related to the observability behavior of the software application;
based on the first set of one or more user inputs, create the first UI element representing the trigger-event condition;
receive, via the user interface, a second set of one or more user inputs for creating a second UI element representing an action to be added to the rule related to the observability behavior of the software application;
based on the second set of one or more user inputs, create the second UI element representing the action; and
send, to a computing platform associated with a software provider of the software application, a request to deploy the rule related to the observability behavior of the software application and thereby cause the computing platform to deploy the rule to a set of one or more computing devices that are installed with the software application, wherein the rule is defined to include the trigger-event condition represented by the first UI element and the action represented by the second UI element.

11. The non-transitory computer-readable medium of claim 10, wherein the non-transitory computer-readable medium is also provisioned with program instructions that, when executed by at least one processor, cause the computing system to:
receive, via the user interface, a third set of one or more user inputs for creating an interconnection between the first and second UI elements that represents a logical if-then relationship between the trigger-event condition and the action; and
based on the third set of one or more user inputs, create the interconnection between the first and second UI elements that represents the logical if-then relationship between the trigger-event condition and the action, wherein the logical if-then relationship is encoded as part of the rule.

12. The non-transitory computer-readable medium of claim 10, wherein the trigger-event condition represented by the first UI element comprises a first trigger-event condition, and wherein the non-transitory computer-readable medium is also provisioned with program instructions that, when executed by at least one processor, cause the computing system to:
receive, via the user interface, a third set of one or more user inputs for creating a third UI element representing a second trigger-event condition to be added to the rule related to the observability behavior of the software application; and
based on the third set of one or more user inputs, create the third UI element representing the trigger-event condition, wherein the rule is defined to include the second trigger-event condition represented by the third UI element.

13. The non-transitory computer-readable medium of claim 12, wherein the non-transitory computer-readable medium is also provisioned with program instructions that, when executed by at least one processor, cause the computing system to:
receive, via the user interface, a fourth set of one or more user inputs for creating a first interconnection between the first and third UI elements that represents a logical AND relationship between the first trigger-event condition and the second trigger-event condition;
based on the fourth set of one or more user inputs, create the first interconnection between the first and third UI elements that represents the logical AND relationship between the first trigger-event condition and the second trigger-event condition;
receive, via the user interface, a fifth set of one or more user inputs for creating a second interconnection between a given one of the first or third UI elements and the second UI element that represents a logical if-then relationship between the trigger-event conditions and the action; and
based on the fifth set of one or more user inputs, create the second interconnection between the first and third UI elements that represents the logical if-then relationship between the trigger-event conditions and the action,
wherein the logical AND relationship and the logical if-then are encoded as part of the rule.

14. The non-transitory computer-readable medium of claim 10, wherein the first set of one or more user inputs for creating the first UI element representing the trigger-event condition includes one or more user inputs that define a client-instance filter for the trigger-event condition, and wherein the first UI element as created further represents the client-instance filter for the trigger-event condition.

15. The non-transitory computer-readable medium of claim 10, wherein the second set of one or more user inputs for creating the second UI element representing the action includes one or more user inputs that define a client-instance filter for the action, and wherein the second UI element as created further represents the client-instance filter for the action.

16. The non-transitory computer-readable medium of claim 10, wherein the user interface for creating the rule comprises a dialog for creating a UI element representing a condition, wherein the dialog includes one or both of (i) a dropdown list of predefined conditions that are selectable by a user or (ii) a set of one or more input fields for defining the condition in terms of a logical expression, and wherein the first set of one or more user inputs includes at least one user input received via the dialog.

17. The non-transitory computer-readable medium of claim 10, wherein the user interface for creating the rule comprises a dialog for creating a UI element representing an action, wherein the dialog includes one or both of (i) a dropdown list of predefined actions that are selectable by a user or (ii) a set of one or more input fields for defining the action in terms of a logical expression, and wherein the second set of one or more user inputs includes at least one user input received via the dialog.

18. The non-transitory computer-readable medium of claim 10, wherein the user interface for creating the rule comprises an icon for creating an interconnection between first UI element and the second UI element, wherein the icon is associated with at least one of the first or second UI elements.

19. A method implemented by a computing system, the method comprising:
presenting a user interface (UI) for creating a rule related to observability behavior of a software application;
receiving, via the user interface, a first set of one or more user inputs for creating a first UI element representing a trigger-event condition to be added to the rule related to the observability behavior of the software application;
based on the first set of one or more user inputs, creating the first UI element representing the trigger-event condition;
receiving, via the user interface, a second set of one or more user inputs for creating a second UI element representing an action to be added to the rule related to the observability behavior of the software application;
based on the second set of one or more user inputs, creating the second UI element representing the action; and
sending, to a computing platform associated with a software provider of the software application, a request to deploy the rule related to the observability behavior of the software application and thereby causing the computing platform to deploy the rule to a set of one or more computing devices that are installed with the software application, wherein the rule is defined to include the trigger-event condition represented by the first UI element and the action represented by the second UI element.

20. The method of claim 19, further comprising:
receiving, via the user interface, a third set of one or more user inputs for creating an interconnection between the first and second UI elements that represents a logical if-then relationship between the trigger-event condition and the action; and
based on the third set of one or more user inputs, creating the interconnection between the first and second UI elements that represents the logical if-then relationship between the trigger-event condition and the action, wherein the logical if-then relationship is encoded as part of the rule.
